(19) United States
(12) Patent Application Publication
(10) Pub. No.: US 2014/0015852 A1
(43) Pub. Date: Jan. 16, 2014

(54) Method Of Processing Image Data From An Electromagnetic Tomography Machine

(71) Applicants: Panagiotis Kantartzis, London (GB); Panagiotis Liatsis, London (GB)

(72) Inventors: Panagiotis Kantartzis, London (GB); Panagiotis Liatsis, London (GB)

(73) Assignee: THE CITY UNIVERSITY, London (GB)

(21) Appl. No.: 13/545,071

(22) Filed: Jul. 10, 2012

(51) Int. Cl. G09G 5/00

(52) U.S. Cl. 345/619

(57) ABSTRACT

A method of generating an image of a material distribution within an object is disclosed herein. The method comprises: obtaining or generating first and second sets of continuous equations; obtaining or generating first and second sets of basis functions; generating a first set and a second set of discretised equations; solving the first set and second set of discretised equations; extracting information regarding a first set and a second set of properties; utilising the information regarding the first and second sets of properties to assemble a forward operator; and utilising object data and the forward operator to generate image data corresponding to an estimation of the material distribution of the object.

### CROSS REFERENCE TO RELATED APPLICATION

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to a method of processing data, in particular to a method for processing data to generate an image of the interior of an object. In an illustrative implementation, the method disclosed herein is (at least partly) embodied in a computer program.

2. Description of the Related Art

Various techniques for generating an image of the interior of an object, such as a human body or an inanimate medium such as a pipe or a tank, have previously been proposed. For example, Electrical Impedance Tomography can be used to generate an image of the internal distribution within a patient (i.e. an image of the interior of the patient) using information captured from their skin. To achieve this, currents are applied across a person's skin and the potential is measured at various skin points (i.e. voltage readings are taken on the boundary surface of the object), and from this data (surface/boundary voltages) it is possible to reconstruct a static image of the patient's internal anatomy. Such measurements (surface/boundary voltages) correspond to boundary data around the patient's body and are thus referred to as “object data.”

It has been previously proposed to couple the underlying EIT equations (i.e. the physical laws that model the physical interaction with the body and enable the aforementioned image to be reconstructed from the surface voltage data) with a set of computational techniques, as a numerical tool for estimating the object data as well as the interior potential distributions. One such technique is the Finite Element Method (FEM) which is employed as a numerical and computational tool to approximate solutions of the EIT equations.

Although FEM techniques are advantageous in that they can handle arbitrary domains, their use in practice provides systems of equations to be solved that are each relatively simple but so large in number that the process of solving these equations rapidly becomes unduly computationally expensive. Another disadvantage is that whilst such techniques can adequately predict object data (i.e. surface data), they are not necessarily as adequate/efficient at approximating data in the interior of the body (such data being known as interior potential distributions or inner/interior field data). The main reason why these disadvantages exist is that the large scale nature of the systems of equations employed in the techniques described above, when practically configured with piece-wise linear basis functions for the interior data, tend not to be numerically sufficient for capturing adequate information when conducting interior field data approximations throughout the entire domain. Often, this inefficiency is interpreted as loss of information.

To alleviate the loss of information, it has previously been proposed to seek more sophisticated methods that incorporate additional information into the imaging problem, by means of more sophisticated solution constraints, and practically counteract the loss of information. For example it has previously been proposed in non-linear optimization schemes (see “Sparsity reconstruction in electrical impedance tomography: An experimental evaluation” by Matthias Gehre, Tobias Kluth, Antti Lipponen, Bangti Jin, Aku Seppanen, Jari P. Kaipio and Pete Maass; Journal of Computational and Applied Mathematics Volume 236, Issue 8, February 2012, Pages 2126-2136) to use sparsity promoting algorithms, often coupled with sparsity transformations, to provide improvements in numerical approximations and eventually in the reconstruction quality, and hence the quality of the images generated. However, conventional FEM techniques are not a practical proposition for performing such numerical operations (due, inter alia, to the fact that such an arrangement would be computationally expensive).

Whilst the techniques described in this paper do provide improvements in the quality of the images achievable, those images are still relatively poor and could readily stand with being yet further improved. FIG. 2 of the aforementioned paper illustrates this point. The left hand column shows a number of photographs of a tank with static obstacles arranged in various different configurations, and the middle column shows the corresponding images of those configurations produced using conventional EIT techniques. As can clearly be seen, much of the information concerning the shape of the objects has been lost, and as such it is difficult to determine the shape of the objects (or other information concerning the objects) from the images. When similar EIT techniques are used to image a dynamic object (for example, for imaging within the human body) the quality of the image is still further reduced, but despite this such images are still useful. For example, the Dräger PumoVista® 500 is used, particularly in critical care units, to enable medical professionals to infer lung information.

The techniques disclosed in the aforementioned paper provide “sparsity promoting reconstructions” (shown in the right hand column of FIG. 2) and these images are indeed of higher quality and visually sharper than those in the central column of FIG. 2.

However, a problem with using techniques such as those described in this paper is that the algorithms employed were originally designed with other applications in mind, and as a consequence it is both technically and computationally challenging to adopt these algorithms for EIT and similar modalities. Another drawback with the particular technique described in the aforementioned paper is that it employs a finite element method which, whilst being relatively easy to code, is inefficient to execute (even when performing relatively straightforward two dimensional image reconstructions such as the ones performed in the paper).

### BRIEF SUMMARY OF THE INVENTION

Aspects of the present invention have been devised with the foregoing problems in mind.

In one proposed implementation, the method involves generating an image by processing data that has been acquired from one or more electromagnetic tomography modalities, such as Electrical Impedance Tomography (EIT), Electrical Capacitance Tomography (ECT), Microwave Tomography (MT), Magnetic Induction Tomography (MIT), Magnetic Permeability Tomography (MPT), Optical Tomography (OT), Thermal Tomography (TT) or Acoustic Tomography (AT).

It will be appreciated, however, that the methods disclosed herein may be utilized for processing other types of data and in a variety of different applications, and as a consequence the illustrative applications described herein should not be interpreted as being a limitation of the scope of the present invention.

In one illustrative implementation of the teachings of the invention, there is provided a method of generating an image of a material distribution within an object, the method comprising the steps of: a) obtaining or generating first and second sets of continuous equations in accordance with a set of imaging laws; b) obtaining or generating first and second sets of basis functions that correspond to the first and second sets of continuous equations respectively; c) generating a first set of discretised equations using the first set of basis functions and the first set of continuous equations; d) generating a second set of discretised equations using the second set of basis functions and the second set of continuous equations; e) solving the first set of discretised equations to generate a first set of solutions; f) solving the second set of discretised equations to generate a second set of solutions; g) extracting information regarding a first set of properties of the object from the first set of solutions; h) extracting information regarding a second set of properties of the object from the second set of solutions; i) utilising the information regarding the first and second sets of properties of the object to assemble a forward operator; and j) utilising object data and the forward operator to generate image data, said image data corresponding to an estimation of the material distribution of the object.

The first and second sets of basis functions obtained or generated in step b) may be refinable.

In one implementation the first set of basis functions; and/or the second set of basis functions are of a single-scale nature or a multi-scale nature.

In one implementation the first set of discretised equations generated in step c) are either a first set of single-scale discretised equations or a first set of multi-scale discretised equations; and/or the second set of discretised equations generated in step d) are either a second set of single-scale discretised equations or a second set of multi-scale discretised equations.

An iterative solver may be used to solve: i) the first set of single-scale discretised equations; ii) the first set of multi-scale discretised equations; iii) the second set of single-scale discretised equations; and/or iv) the second set of multi-scale discretised equations.

An iterative solver preconditioned with multigrid or an iterative solver of multigrid-type may be used to solve: i) the first set of single-scale discretised equations, thereby generating a first set of single-scale solutions; and/or ii) the second set of single-scale discretised equations, thereby generating a second set of single-scale solutions.

An iterative solver preconditioned with multilevel preconditioning may be used to solve: i) the first set of multi-scale discretised equations, thereby generating a first set of multi-scale solutions; and/or ii) the second set of multi-scale discretised equations, thereby generating a second set of multi-scale solutions.

In one implementation step g) involves extracting a first set of single-scale properties of the object from the first set of single-scale solutions; and/or step h) involves extracting a second set of single-scale properties of the object from the second set of single-scale solutions.

In one implementation step g) involves extracting a first set of multi-scale properties of the object from the first set of multi-scale solutions; and/or step h) involves extracting a second set of multi-scale properties of the object from the second set of multi-scale solutions.

In one implementation step i) involves utilizing the first and second sets of extracted single-scale properties to generate a single-scale forward operator.

In one implementation step i) involves utilizing the first and second sets of extracted multi-scale properties and/or the first set of single-scale properties and/or the second set of single-scale properties to generate a multi-scale forward operator.

In one implementation step j) involves using object data and the single-scale forward operator to generate single-scale image data.

In one implementation step j) involves using object data and the multi-scale forward operator to generate multi-scale image data.

The single-scale forward operator may be inverted to generate single-scale image data.

The single-scale forward operator may be inverted by using: i) a linear solution process; ii) a non-linear solution process; and/or iii) a regularization process.

The multi-scale forward operator may be inverted to generate multi-scale image data.

The multi-scale forward operator may be inverted by using: i) a linear solution process; ii) a non-linear solution process; and/or iii) a regularization process.

In one implementation single-scale image data may be used to calibrate the single-scale forward operator. In another implementation multi-scale image data to calibrate the multi-scale forward operator.

In another illustrative implementation of the teachings of the invention, there is provided a computer program for generating an image of a material distribution within an object, the computer program comprising: a) a first software module for obtaining or generating first and second sets of continuous equations in accordance with a set of imaging laws; b) a second software module for obtaining or generating first and second sets of basis functions that correspond to the first and second sets of continuous equations respectively; c) a third software module for generating a first set of discretised equations using the first set of basis functions and the first set of continuous equations; d) a fourth software module for generating a second set of discretised equations using the second set of basis functions and the second set of continuous equations; e) a fifth software module for solving the first set of discretised equations to generate a first set of solutions; f) a sixth software module for solving the second set of discretised equations to generate a second set of solutions; g) a seventh software module for extracting information regarding a first set of properties of the object from the first set of solutions; h) an eighth software module for extracting information regarding a second set of properties of the object from the second set of solutions; i) a ninth software module for utilizing the information regarding the first and second sets of properties of the object to assemble a forward operator; and j) a tenth software module for utilizing object data and the forward operator to generate image data, said image data corresponding to an estimation of the material distribution of the object.

Techniques embodying the teachings of the present invention employ multi-level basis functions, commonly referred to as wavelets, instead of piece-wise linear polynomial basis functions as in finite elements (as in the techniques described in the abovementioned paper), and as a direct consequence many computations are significantly simplified and less computationally expensive (even when relatively low powered computing resources are employed).

Another advantage of the technique disclosed herein is that the functions and variables employed during computations can be automatically compressed, which in turn means that the reconstructed images produced with this technique could “inherently” be compressed (something that is not possible with finite element techniques). On a practical level, this means that when storing images in real time the number of variables that need to be stored can be greatly reduced, without compromising the quality of the final result.

Compressibility of the data also provides the ability for a numerical platform to be devised that, once running, is operable to automatically add or discard variables until an enhanced set of variables is achieved, or in other words for a platform to be devised that enables the level of complexity in each instance to be automatically controlled (so-called numerical adaptivity). This provides the opportunity for power management and saving, and control of balance in computations. The techniques disclosed herein further provide a means for capturing mathematical singularities that may cause numerical instabilities.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

Various aspects of the teachings of the present invention, and arrangements embodying those teachings, will hereafter be described by way of illustrative example with reference to the accompanying drawings, in which:

FIG. 1 is an illustrative schematic representation of a computing resource;

FIG. 2 is a schematic diagram showing a functional operative relationship established by hardware and software of the system depicted in FIG. 1;

FIG. 3 is a schematic representation of the functional steps employed in the image data generation method described herein;

FIGS. 4 and 5 are schematic representations of the functional steps executed by the Equation Procurement Module to generate first and second sets of continuous equations, respectively;

FIGS. 6 and 7 are schematic representations of the functional steps executed by the Basis Function Procurement Module to generate first and second sets of basis functions, respectively;

FIGS. 8 and 9 are schematic representations of the functional steps executed by the Discretised Equation Generator Module to generate a first set of discretised equations;

FIGS. 10 and 11 are schematic representations of the functional steps executed by the Discretised Equation Generator Module to generate a second set of discretised equations;

FIGS. 12 to 14 are schematic representations of the functional steps executed by the Equation Solver Module to generate a first set of solutions;

FIGS. 15 to 17 are schematic representations of the functional steps executed by the Equation Solver Module to generate a second set of solutions;

FIGS. 18 and 19 are schematic representations of the functional steps executed by the Property Extraction Module to generate first and second sets of properties, respectively;

FIG. 20 is a schematic representation of the functional steps executed by the Operator Generator Module to generate a forward operator;

FIG. 21 is a schematic representation of the functional steps executed by the Image Generator Module to generate image data; and

FIG. 22 is a schematic representation of the functional steps executed by the Calibration Module.

FIG. 23 is an illustration of one embodiment of a system for processing data to generate an image of an interior of an object in which an image of an internal anatomy of a patient is displayed on a monitor connected to a computer with a processor configured to generate the EIT image in accordance with a method of the present invention.

### DETAILED DESCRIPTION OF THE INVENTION

Aspects of the present invention will now be described with reference to the accompanying drawings, and with particular reference to the processing of data for the generation of images (in particular, images derived from EIT data). It will be appreciated, however, that the techniques described herein may be applied to other types of data and in other applications, and hence the following detailed description should not be interpreted as limiting the scope of the present invention in any way.

The following detailed description refers, in places, to academic papers, textbooks and other materials and where such references are made the papers, textbooks and other materials concerned should be considered to be incorporated herein by reference as though they were reproduced in their entirety in this

### DETAILED DESCRIPTION

With the above proviso in mind, reference will now be made to FIG. 1 of the accompanying drawings in which there is schematically depicted an illustrative computing resource 1. The computing resource may comprise a personal computer (PC) or in other envisaged arrangements, the computing resource may be incorporated into a larger item of equipment—such as a control system for an electromagnetic tomography machine. In general terms, the computing resource may comprise any programmable computing device.

The computing resource 1 of this illustrative embodiment comprises a system bus that interconnects, for signal transmission and reception purposes, a processor, memory (for example RAM and/or ROM), a data store (such as a hard disk drive or other data storage device), a network interface (such as a LAN or WLAN interface), a peripheral interface (such as a USB, RS232 or other interface) to permit signal transfer between the computing resource and one or more peripherals (such as a pointing device, keyboard etc), and a video controller that is capable of generating video signals for display on a display (not shown).

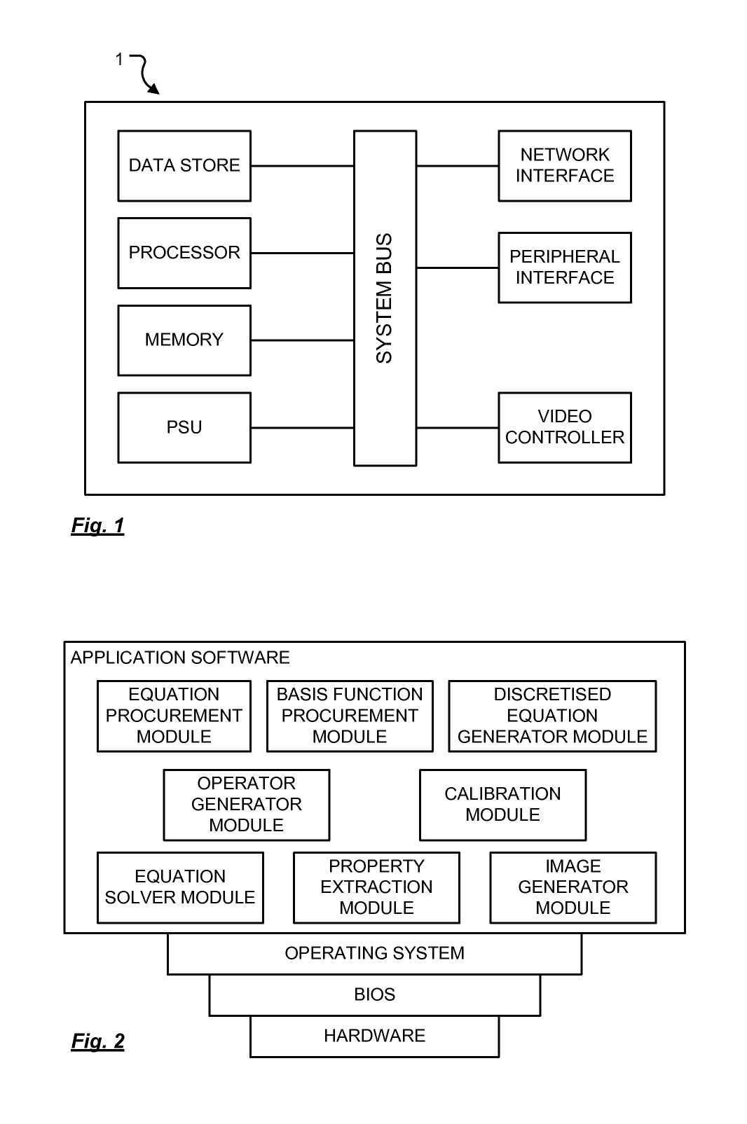

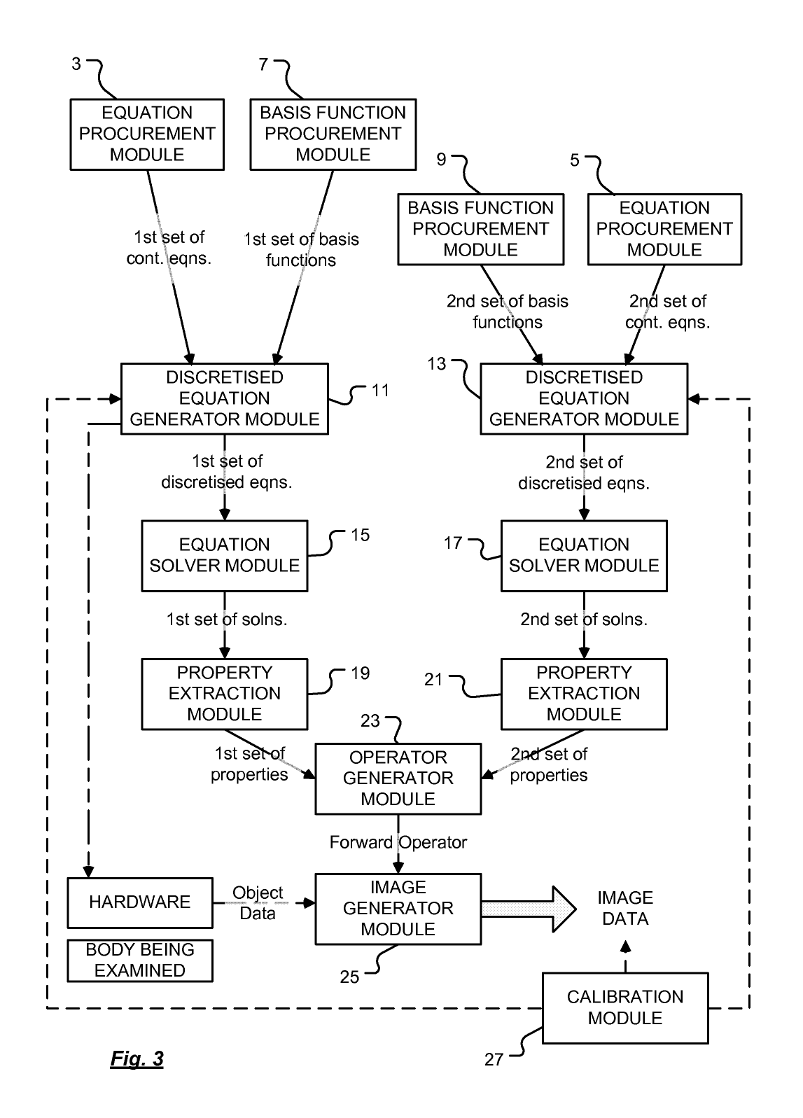

Referring now to FIG. 2, there is a depicted a schematic illustration of the functional relationship between hardware and software of the computing resource. The processor and memory cooperate to establish a BIOS (Basic Input/Output System) that functions as an interface between the functional hardware components of the computing resource (for example the components depicted in FIG. 1) and the software executed by the computing resource. The processor then loads, for example from memory or other storage facility, an operating system which provides an execution environment in which application software can be executed.

In this embodiment, the application software comprises a plurality of software modules that functionally co-operate to implement the data processing method described herein. In particular, the application software comprises an equation procurement module that is configured to generate or retrieve from storage (as appropriate) first and second sets (in one implementation, the second set of equations comprises the adjoint of the first) of continuous equations that define the physical, mathematical and/or numerical principles governing the particular type of electromagnetic tomography used to acquire the data that is to be processed. The equation procurement module may be configured, as is described in more detail below, to process and thereby refine the sets of continuous equations chosen for the particular electromagnetic tomography modality being used.

The application software further comprises a basis function procurement module that is configured to generate (or load from a data store) first and second sets of (single or multi-scale) basis functions (corresponding to the first and second sets of continuous equations obtained by the equation procurement module) that factor in the mathematical constraints of the chosen electromagnetic tomography modality being used.

A discretised equation generator module is provided, and is configured to generate a first set of (single or multi-scale) discretised equations from the first set of continuous equations (obtained by the equation procurement module) and the first set of (single or multi-scale) basis functions (obtained by the basis function procurement module), and a second set of discretised (single or multi-scale) equations from the second set of continuous equations (obtained by the equation procurement module) and the second set of (single or multi-scale) basis functions (obtained by the basis function procurement module).

An equation solver module is provided, and is configured to solve (in one envisaged implementation, via an iterative process) the first and second sets of (single or multi-scale) discretised equations generated by the discretised equation generator module. The application software further comprises a property extraction module that is configured to extract, from the (single or multi-scale) solutions provided by the equations solver module, first and second sets of (single or multi-scale) properties, where those properties are associated with problem specific parameters.

An operator generator module is provided and is configured to generate a (single or multi-scale) forward operator, from the first and second sets of (single or multi-scale) properties provided by the property generator module. An image generator module is provided and configured to generate (single or multi-scale) image data from object data (i.e. data from the object being imaged by the particular electromagnetic tomography modality being used) and the (single or multi-scale) forward operator provided by the operator generator module.

A calibration module may also be provided, the calibration module being operable to calibrate the (single or multi-scale) forward operator using additional information concerning the object, and thereby provide a calibrated (single or multi-scale) forward operator that better matches the object data.

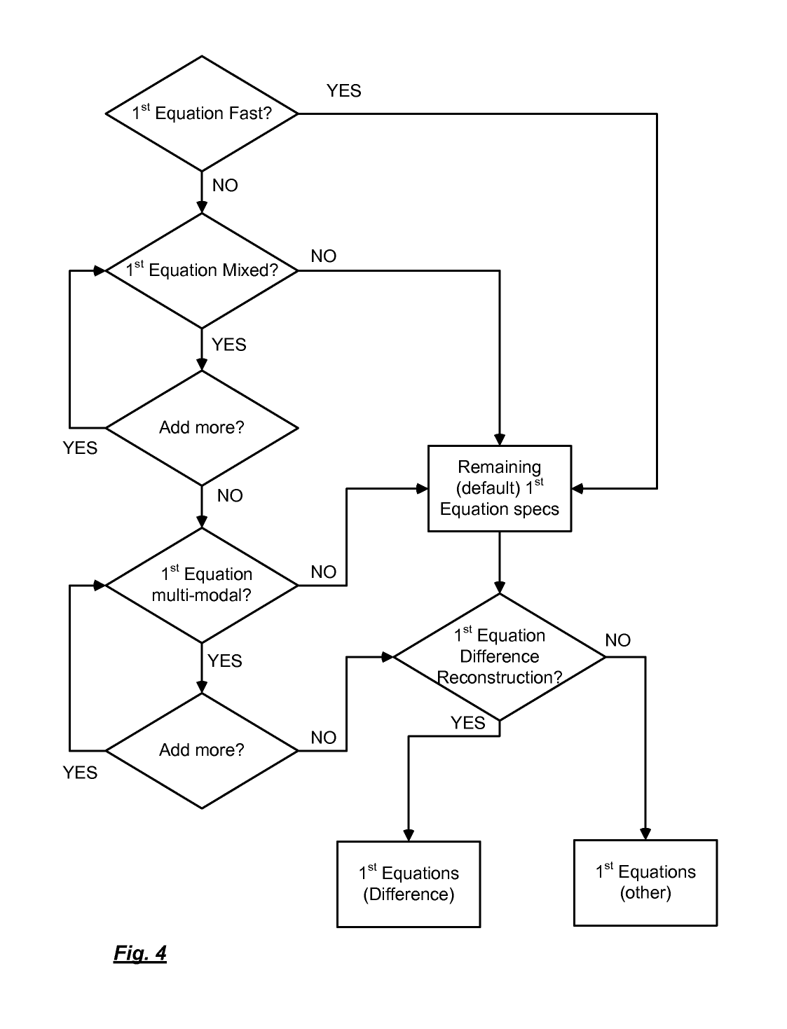

The functionality of each of the software application modules will now be described in more detail with reference to FIG. 3 of the accompanying drawings, in which there is depicted a schematic representation of the functional steps employed to effect the data processing method disclosed herein. That method may be employed, as will now be described, to process data that has been acquired using single (or multi) modality electromagnetic tomography.

In a first functional step of the method, the equation procurement module obtains first and second sets of continuous equations, either by generating those equations or by retrieving them from a data store. Such continuous equations are in accordance with a set of physical laws which depend on the type of electromagnetic tomography modality used to obtain the data to be processed.

In particular, each imaging modality is assumed to obey a plurality of physical and/or mathematical and/or numerical laws, e.g., electric and/or magnetic and/or optic and/or acoustic. According to the imaging task at hand, combinations and/or simplifications and/or further calculations are carried out, as required, to derive a sufficiently accurate continuous mathematical model, amenable to further numerical processing on a computer. For example, for optical imaging modalities a diffusion approximation equation (such as that presented in Arridge, S. R. Methods in diffuse optical imaging. PHILOS T R SOC A 369 (1955), 4558-4576, 2011) could be employed to address imaging problems where fast computations are required. For the EIT case, a typical simplification is a lower frequency approximation of the Maxwell equations that provides a second order generalized Laplacian. This is subject to boundary conditions, such as for example the ones described by the so called complete electrode model in “Existence and Uniqueness for Electrode Models for Electric Current Computed Tomography” by E. Somersalo, M. Cheney, D. Isaacson, SIAM J. App. Math., 52, 4, 1023-1040, 1992.

It is also envisaged to undertake further calculations as required by the desired solution specifications, to further reduce the computational requirements using, for example, techniques such as the so-called Boundary Element Method and/or the weak formulation, details of each of which can be found in John T. Katsikadelis, “Boundary Elements: Theory and Applications”, Elsevier Science, 2002, to provide the aforementioned first set of continuous equations. For less complex imaging cases, the first set of continuous equations could either be generated or retrieved from a data store.

In general, the first set of equations is a set of differential equations, typically partial differential equations (PDEs), coupled with sets of initial and/or boundary conditions. In a similar manner, the equation procurement module also obtains a second set of continuous equations, mathematically related to the first one, as for instance the so called Adjoint form of the first set of continuous equations.

In the next functional step of the method, first and second sets of basis functions are obtained from a data store or generated by a user defined method. In one implementation, said method takes into account a set of physical, practical and mathematical constraints associated with the imaging modality being used. For example, if faster results are required, basis functions of lower smoothness may be employed. In one implementation where real-time (fast) results are required, a basis function of minimum smoothness is assigned to each function in the set that forms the first set of continuous equations. In one EIT implementation, linear combinations of linear B-splines may be assigned to the set of basis functions that approximate the potential function.

The first and second sets of basis functions correspond to the first and second sets of continuous equations mentioned above, respectively. The first and second sets of basis functions are refinable and enable multiresolution. The first set of basis functions and/or the second set of basis functions may be of a single-scale nature (for example, B-Splines) or a multi-scale nature (for example, B-spline Wavelets), thereby approximating involved functions in either a single-scale or multiscale fashion. For example, a multi-scale basis function approximation to a function, eg, the material distribution (i.e. the distribution of material within the object being imaged), enables a multi-scale material distribution.

Once the sets of basis functions have been obtained, the discretised equation generator module is executed to generate a first set of discretised equations using the aforementioned first set of basis functions and the first set of continuous equations (provided by the equation procurement module). In one implementation of the present invention it is envisaged that the first set of such discretised equations are either a first set of single-scale discretised equations or a first set of multi-scale discretised equations.

The discretised equation generator then generates a second set of discretised equations using the aforementioned second set of basis functions and the second set of continuous equations. In one implementation of the present invention it is envisaged that the second set of such discretised equations are either a second set of single-scale discretised equations or a second set of multi-scale discretised equations.

Once the discretised equations have been generated, the Equation Solver Module is invoked and executed to generate a first set of solutions by solving the aforementioned first set of discretised equations. In one implementation it is envisaged that an iterative solver is employed to solve for the first set of single-scale discretised equations. In this instance, the iterative solver may comprise a multigrid solver or a Krylov-subspace iterative solver preconditioned with a multigrid preconditioning scheme (see for instance D. Braess, Finite Elements: Theory, Fast Solvers, and Applications in Solid Mechanics, Cambridge University Press, 2007 and similar textbooks), operable to generate a first set of single-scale solutions. In another implementation an iterative solver is employed to solve for the first set of multi-scale discretised equations, and in this instance the iterative solver may be preconditioned with multilevel preconditioning (see P. Kantartzis, A. Kunoth, R, Pabel and P. Liatsis, “Wavelet preconditioning for EIT”, ICEBI 2010 for an EIT implementation of a multilevel preconditioning), thereby generating a first set of multi-scale solutions.

Next, the equation solver module is invoked and executed to generate a second set of solutions by solving the aforementioned second set of discretised equations. Once again, an iterative solver may be employed to solve for the second set of single-scale discretised equations. In one implementation, that iterative solver may comprise a multigrid solver or a Krylov iterative solver preconditioned with a multigrid preconditioning scheme, thereby generating a second set of single-scale solutions. In a second implementation an iterative solver may be employed to solve for the second set of multi-scale discretised equations, and in this instance the iterative solver may be preconditioned with multilevel preconditioning (see P. Kantartzis, A. Kunoth, R, Pabel and P. Liatsis, “Wavelet preconditioning for EIT”, ICEBI 2010 for an EIT implementation of a multilevel preconditioning) thereby generating a second set of multi-scale solutions.

Once the first and second set of solutions have been generated, the property extraction module is invoked and executed to extract a first set of properties from the aforementioned first set of solutions. In one implementation it is envisaged that a first set of single-scale properties is extracted from the first set of single-scale solutions. Such single-scale properties are associated with problem specific parameters such as, for example, single-scale interior fields estimation, single-scale boundary data estimation, partial derivatives with respect to single-scale material distribution, etc, thereby generating a first set of single-scale properties. In a second implementation it is envisioned that a first set of multi-scale properties is extracted from the first set of multi-scale solutions. Such multi-scale properties are associated with problem specific parameters as for instance, multi-scale interior fields, multi-scale boundary data estimation, partial derivatives with respect to multi-scale material distribution, etc, thereby generating a first set of multi-scale properties.

The solution extraction module then extracts a second set of properties from the aforementioned second set of solutions. In one implementation it is envisaged that a second set of single-scale properties is extracted from the second set of single-scale solutions. Such single-scale properties are associated with problem specific parameters as for instance, single-scale interior fields estimation, single-scale boundary data estimation, partial derivatives with respect to single-scale material distribution, etc thereby generating a second set of single-scale properties. In a second implementation it is envisioned that a second set of multi-scale properties is extracted from the second set of multi-scale solutions. Such multi-scale properties are associated with problem specific parameters as for instance, multi-scale interior fields, multi-scale boundary data estimation, partial derivatives with respect to multi-scale material distribution, etc. thereby generating a second set of multi-scale properties; In some implementations, multi-scale properties may be combined with single-scale properties.

Next, the operator generator module is invoked and executed to generate a forward operator from the aforementioned first and second set of properties.

In one implementation it is envisaged that the first set of single-scale properties is associated with the single-scale solution of the forward problem and the second set of single-scale properties is associated with the single-scale solution of the mathematical adjoint of the forward problem. In effect, this implies the use of single-scale forward and adjoint interior fields, thereby generating a single-scale forward operator. In a further implementation it is envisioned, that some of the parts of the assembly of the single-scale forward operator could be precomputed, stored and used as look-up tables, thereby paving the way for matrix-free or matrix-vector implementations of the single-scale forward operator.

In another implementation it is envisaged that the first set of multi-scale properties is associated with the multi-scale solution of the forward problem and the second set of multi-scale properties is associated with the multi-scale solution of the mathematical adjoint of the forward problem. In effect, this implies the use of multi-scale forward and adjoint interior fields, thereby generating a multi-scale forward operator. Once again, some of the parts of the assembly of the multi-scale forward operator could be precomputed, stored and used as look-up tables, thereby paving the way for matrix-free or matrix-vector implementations of the multi-scale forward operator.

In the next step of the method, the image generator module is executed to generate image data from object data and the forward operator.

In one arrangement, the image data may be generated by applying a numerically stabilized inverse of the single scale forward operator (described below as the inversion scheme in an image generator module) to the object data to provide single-scale image data. In one implementation, the single-scale forward-operator may be linearized and the material distribution, which is inferred from the object data using a numerically stabilized inverse of the single scale forward-operator may be approximated using a linear process, e.g. a Tikhonov based regularized solution. In another arrangement the material distribution solution may be approximated using a non-linear process such as a gradient method (for example Newton's method coupled with a single-scale regularisation operator, such as a first order single-scale derivative operator and/or a sparsity promoting algorithm).

In another arrangement the image data may be generated by applying a numerically stabilized inverse of the mutli-scale forward operator (again, described below as the inversion scheme in an image generator module) to the object data to provide multi-scale image data. In one implementation, the multi-scale forward-operator may be linearized and the material distribution may be approximated using a linear solution process, for example a Tikhonov based regularized solution. The multi-scale forward-operator may be linearized and the material distribution solution may be approximated using a non-linear solution process such as a gradient method (for example, Newton's method coupled with a first order multi-scale regularisation operator, such as a first order multi-scale derivative operator).

In another implementation, the multi-scale forward-operator may be inverted by a non-linear solution process involving a sparsity constraint, for example an L1-constraint about the solution, for example something akin to iterative soft-shrinkage methods.

Once the image data has been generated, using the aforementioned method, it may be displayed to an operator using conventional means.

As aforementioned, it is also envisaged to calibrate the single-scale forward-operator using the object data and/or the single-scale material distribution. This calibration could be coupled with permutations of the boundary surface of the object, thereby generating a calibrated single-scale forward operator that better matches object data.

The multi-scale forward-operator may also be calibrated using the object data and/or the multi-scale material distribution. This calibration could again be coupled with permutations of the boundary surface of the object, thereby generating a calibrated multi-scale forward operator that better matches object data.

Each of the functional steps depicted in FIG. 3 will now be described in more detail.

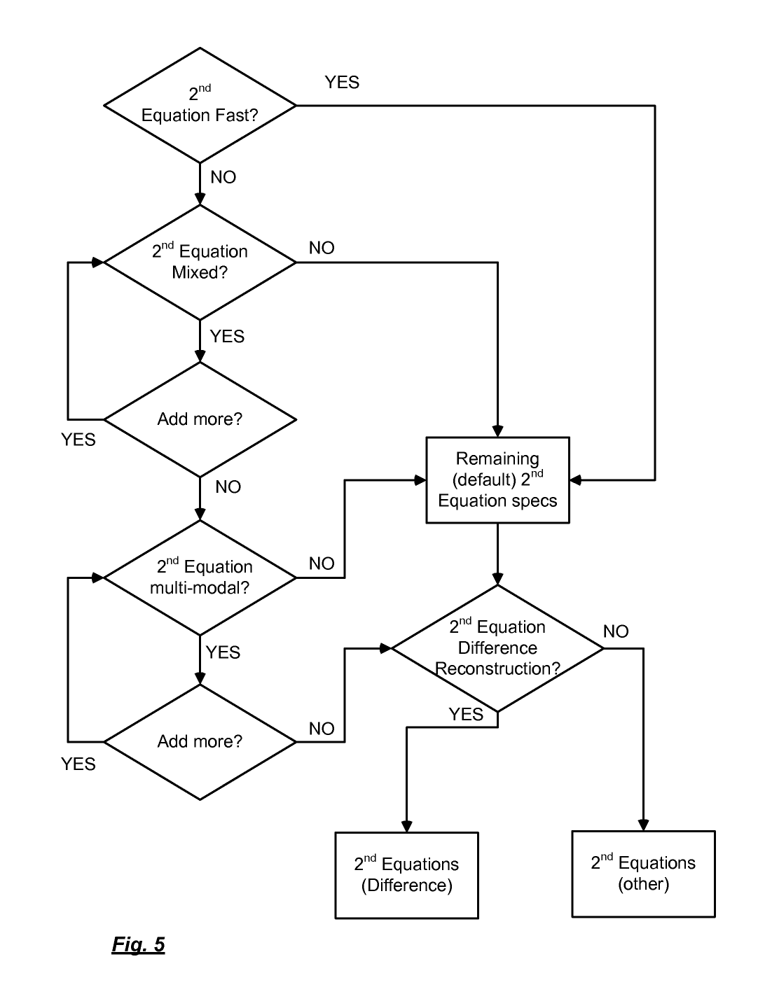

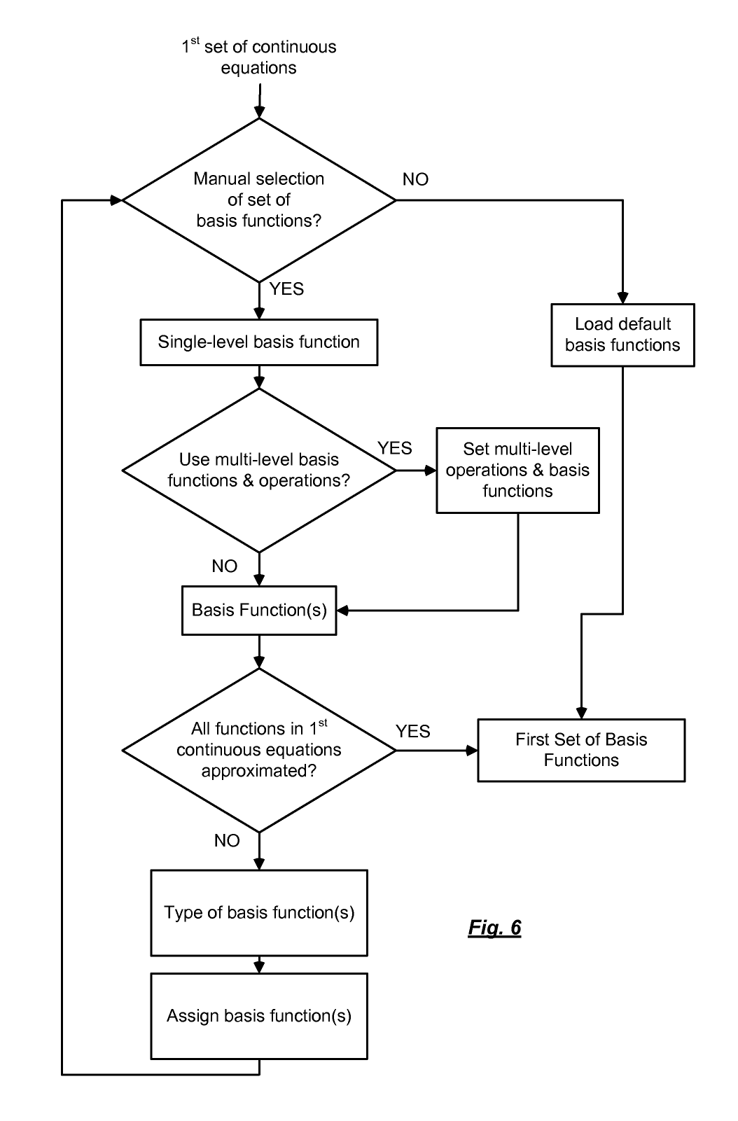

FIGS. 4 and 5 of the accompanying drawings depict flow charts illustrating the functional steps 3, 5 (FIG. 3) invoked by the Equation Procurement Module to obtain the aforementioned first set of continuous equations (FIG. 4) and the aforementioned second set of continuous equations (FIG. 5).

Referring to FIG. 4, the equation procurement module—depending on the particular imaging task at hand—either retrieves input arguments (such as variables, files, vectors, matrices, etc) from a data store or prompts the user to input the necessary arguments. To properly explain the teachings of the present invention, let us assume that the user is prompted to define the arguments.

In a first step, the user is prompted to configure the mode of imaging to be used, in particular whether fast image reconstruction (i.e. a low level continuous model approximation—that is to say, a low-quality approximation of the target image involving sets of less accurate and computationally less expensive mathematical models) or slower image reconstruction (ie, more accurate and computationally more expensive mathematical models) to carry out the image reconstruction task should be undertaken. In the particular case of single-modality EIT imaging, a lower-frequency approximation of Maxwell's equations (such as that described in “Existence and Uniqueness for Electrode Models for Electric Current Computed Tomography” by E Somersalo, M Cheney and D Isaacson. SIAM J. App. Math., 52(4) 1992, 1023-1040) could lead to fast image reconstructions. For the non-fast case, a higher-frequency model involving full Maxwell's equations (such as those disclosed in the following paper: N. K. Soni, K. D. Paulsen, H. Dehghani and A. Hartov, “Finite element implementation of Maxwell's equations for image reconstruction in electrical impedance tomography”, IEEE, Trans. Med. Imaging, 25(1), 55-61, 2006, could be used.

If the user should opt for the non-fast case, the software prompts the user to define the type of problem formulation (mixed or single-formulation implementation) to be used. One illustrative mixed implementation is the FEM-BEM (Finite Element Method—Boundary Element Method) applied to optical imaging in the following paper: J. Elisee, A. Gibson, S. Arridge. Combination of Boundary Element Method and Finite Element Method in Diffuse Optical Tomography, IEEE Trans. Biom. Eng., 57(11), 2737-2745, 2010. Since a plurality of problem formulations could be employed, the software executes a loop until all desired formulations are taken into account. For the single formulation case, a Domain Embedding Method (DEM)—for example that which is disclosed in the following paper: A. Kunoth, Wavelet Techniques for the Fictitious-Domain-Lagrange-Multiplier-Approach, Num. Alg., 27(3), 291-316, 2001,—may be employed.

Next the user is prompted to configure the type of modality imaging to be employed, specifically whether single- or multi-modality imaging should be employed. As a plurality of modalities could be employed, the software is configured to execute a loop until all desired/available modalities are taken into account. For the multimodality case, an EIT-MIT formulation (i.e. an Electrical Impedance Tomography—Magnetic Induction Tomography formulation) of the type described in the following paper D. Gürsoy, Y. Mamatjan, A. Adler, H. Scharfetter, Enhancing Impedance Imaging Through Multimodal Tomography. IEEE Trans. Biomed. Eng. 58, (11), 3215-3224, 2011, may be employed. For the single modality case, the software adopts the default imaging method, for example in the case of an EIT formulation, the software loads the set of EIT-specific equations.

Next, the software prompts the user to define the desired imaging mode which, by default is set to difference imaging, which indicates that differences between two states are sought, effectively requiring the difference of object data between two states (i.e, a plurality of object data). The equation procurement module outputs continuous equations for non-fast reconstructions, mixed formulation, multimodality imaging, difference reconstruction, where derived first set of continuous equations typically imply non-stationary model domains, non-linear computational models.

In one implementation, a default configuration sets input arguments to fast, single formulation BEM, single imaging modality, difference reconstruction, where the derived first set of continuous equations imply stationary models and linearized approximations.

In one envisaged implementation, a default configuration sets input arguments to combinations of aforementioned input arguments, ie, fast, mixed formulation, single imaging modality, non-difference reconstruction.

The functional steps invoked by the Equation Procurement Module to obtain the second set of continuous equations will now be described.

Referring to FIG. 5, the equation procurement module—depending on the particular imaging task at hand—either retrieves input arguments (such as variables, files, vectors, matrices, etc) from a data store or prompts the user to input the necessary arguments. To properly explain the teachings of the present invention, let us assume that the user is prompted to define the arguments.

In a first step, the user is prompted to configure the mode of imaging to be used, in particular whether fast image reconstruction (i.e. a low level continuous model approximation—that is to say, a low-quality approximation of the target image involving sets of less accurate and computationally less expensive mathematical models) or slower image reconstruction (ie, more accurate and computationally more expensive mathematical models) to carry out the image reconstruction task should be undertaken. In the particular case of single -, modality EIT imaging, a lower-frequency approximation of Maxwell's equations (such as that described in “Existence and Uniqueness for Electrode Models for Electric Current Computed Tomography” by E Somersalo, M Cheney and D Isaacson. SIAM J. App. Math., 52(4) 1992, 1023-1040) could lead to fast image reconstructions. For the non-fast case, a higher-frequency model involving full Maxwell's equations (such as those disclosed in the following paper: N. K. Soni, K. D. Paulsen, H. Dehghani and A. Hartov, “Finite element implementation of Maxwell's equations for image reconstruction in electrical impedance tomography”, IEEE, Trans. Med. Imaging, 25(1), 55-61, 2006.

If the user should opt for the non-fast case, the software prompts the user to define the type of problem formulation (mixed or single formulation implementation) to be used. One illustrative mixed implementation is the FEM-BEM (Finite Element Method—Boundary Element Method) applied to optical imaging in the following paper: J. Elisee, A. Gibson, S. Arridge. Combination of Boundary Element Method and Finite Element Method in Diffuse Optical Tomography, IEEE Trans. Biom. Eng., 57(11), 2737-2745, 2010. Since a plurality of problem formulations could be employed, the software executes a loop until all desired formulations are taken into account. For the single formulation case, a Domain Embedding Method (DEM)—for example that which is disclosed in the following paper: A. Kunoth, Wavelet Techniques for the Fictitious-Domain-Lagrange-Multiplier-Approach, Num. Alg., 27(3), 291-316, 2001,—may be employed.

Next the user is prompted to configure the type of modality imaging to be employed, specifically whether single- or multi-modality imaging should be employed. As a plurality of modalities could be employed, the software is configured to execute a loop until all desired/available modalities are taken into account. For the multimodality case, an EIT-MIT formulation (i.e. an Electrical Impedance Tomography—Magnetic Induction Tomography formulation) of the type described in the following paper D. Gürsoy, Y. Mamatjan, A. Adler, H. Scharfetter, Enhancing Impedance Imaging Through Multimodal Tomography. IEEE Trans. Biomed. Eng. 58, (11), 3215-3224, 2011 may be employed. For the single modality case, the software adopts the default imaging method, for example in the case of an EIT formulation, the software loads a set of EIT-specific equations.

Next, the software prompts the user to define the desired imaging mode which, by default is set to difference imaging, which indicates that differences between two states are sought, effectively requiring the difference of object data between two states (i.e, a plurality of object data). The equation procurement module outputs continuous equations for non-fast reconstructions, mixed formulation, multimodality imaging, difference reconstruction, where derived second set of continuous equations typically imply non-stationary model domains, non-linear computational models.

In one implementation, a default configuration sets input arguments to fast, single formulation BEM, single imaging modality, difference reconstruction, where the derived second set of continuous equations imply stationary models and linearized approximations.

In one envisaged implementation, a default configuration sets input arguments to combinations of aforementioned input arguments, ie, fast, mixed formulation, single imaging modality, non-difference reconstruction.

It is also envisaged that the second set of continuous equations may comprise the adjoint formulation of the aforementioned first set of continuous equations.

The functional steps 7, 9 (FIG. 3) invoked by the Basis Function Procurement Module to obtain the first and second sets of basis will now be described.

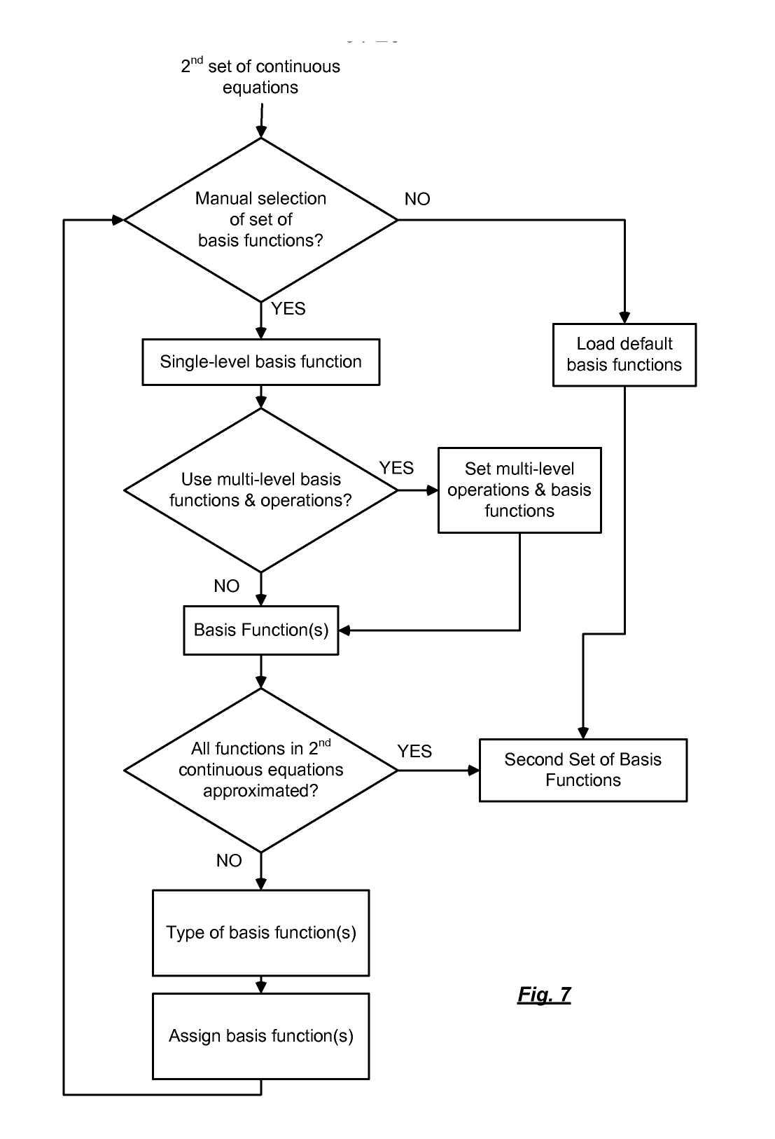

As shown in FIG. 6, the basis function procurement module—depending on the particular imaging task at hand—is configured to either load a default set of basis functions from a data store (for example, basis functions of the type described in W. Dahmen, A. Kunoth, K. Urban, Biorthogonal Spline-Wavelets on the Interval—Stability and Moment Conditions, Appl. Comp. Harm. Anal. 6, 1999, 132-196), or to prompt the user to manually assign a basis function for each mathematical function that makes up the 1^{st} set of continuous equations.

To properly explain the teachings of the present invention, let us assume that the user opts to manually select the set of basis functions.

In a first step, the software loads a single-level basis function, and then prompts the user to configure the multilevel operations and basis functions. That is, a set of mathematical operations to transform the aforementioned single-level basis function to a set of multi-level basis functions (suitable examples of single level basis functions, multi-level basis functions and operations are described in the aforementioned paper by W. Dahmen, A. Kunoth, and K. Urban).

In one implementation combinations of single-level and/or combinations of multilevel basis functions are used, for example the basis functions described in G. Plonka, V. Strela, From wavelets to multiwavelets, Math. Meth. Curv. Surf. II, Vanderbilt University Press, 1998, may be employed.

Thus, either a single level basis function or a set of multilevel basis functions are assigned to functions that make up the 1^{st} set of continuous equations for their numerical approximations. That is, each function involved in the 1^{st} set of continuous equations is numerically approximated by one or more proposed basis functions. Since a plurality of functions make up the 1^{st} set of continuous equations, the software executes a loop until either a single level basis function or a set of multilevel basis functions is assigned to each function that makes up the 1^{st} set of continuous equations. The user is also, in a preferred arrangement, provided with the opportunity to specify the types of basis function, for example primal/dual and/or isotropic/anisotropic definitions, to be employed.

Once all the mathematical functions that make up the first set of continuous equations have been approximated, the basis module procurement module outputs a first set of basis functions.

Referring now to FIG. 7, the functional steps employed to obtain the second set of basis functions will now be described.

The basis function procurement module—depending on the particular imaging task at hand—is configured to either load a default set of basis functions from a data store (for example, basis functions of the type described in W. Dahmen, A. Kunoth, K. Urban, Biorthogonal Spline-Wavelets on the Interval—Stability and Moment Conditions, Appl. Comp. Harm. Anal. 6, 1999, 132-196), or to prompt the user to manually assign a basis function for each mathematical function that makes up the 2^{nd} set of continuous equations.

To properly explain the teachings of the present invention, let us assume that the user opts to manually select the set of basis functions.

In a first step, the software loads a single-level basis function, and then prompts the user to configure the multilevel operations and basis functions. That is, a set of mathematical operations to transform the aforementioned single-level basis function to a set of multi-level basis functions (suitable examples of single level basis functions, multi-level basis functions and operations are described in the aforementioned paper by W. Dahmen, A. Kunoth, and K. Urban).

In one implementation combinations of single-level and/or combinations of multilevel basis functions are used, for example the basis functions described in G. Plonka, V. Strela, From wavelets to multiwavelets, Math. Meth. Curv. Surf. II, Vanderbilt University Press, 1998, may be employed. Thus, either a single level basis function or a set of multilevel basis functions are assigned to functions that make up the 2^{nd} set of continuous equations for their numerical approximations. That is, each function involved in the 2^{nd} set of continuous equations is numerically approximated by one or more proposed basis functions. Since a plurality of functions make up the 2^{nd} set of continuous equations, the software executes a loop until either a single level basis function or a set of multilevel basis functions is assigned to each function that makes up the 2^{nd} set of continuous equations. The user is also, in a preferred arrangement, provided with the opportunity to specify the types of basis function, for example primal/dual and/or isotropic/anisotropic definitions, to be employed.

Once all the mathematical functions that make up the second set of continuous equations have been approximated, the basis function procurement module outputs a second set of basis functions.

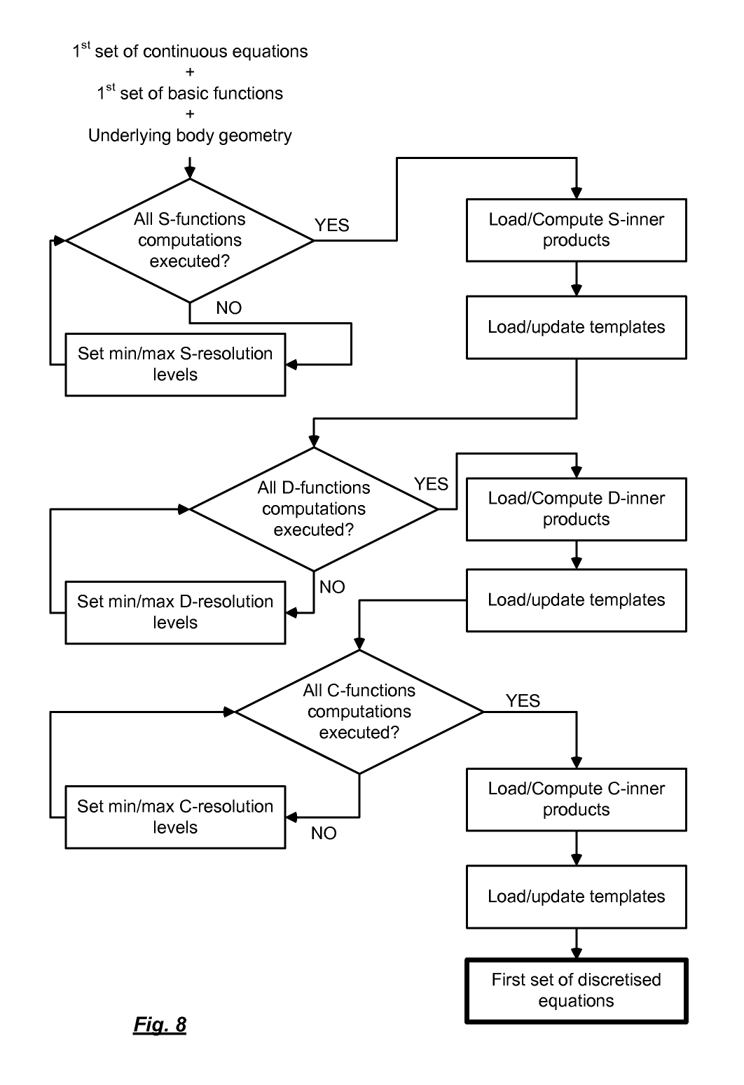

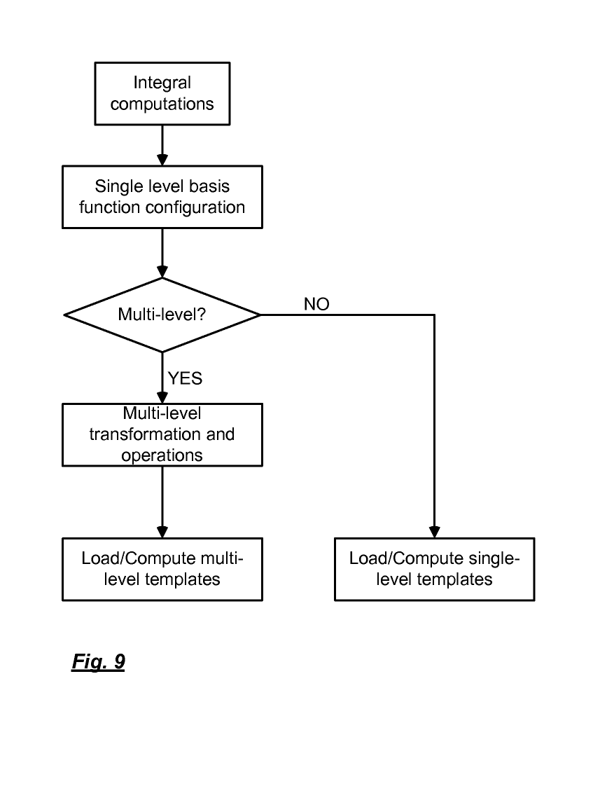

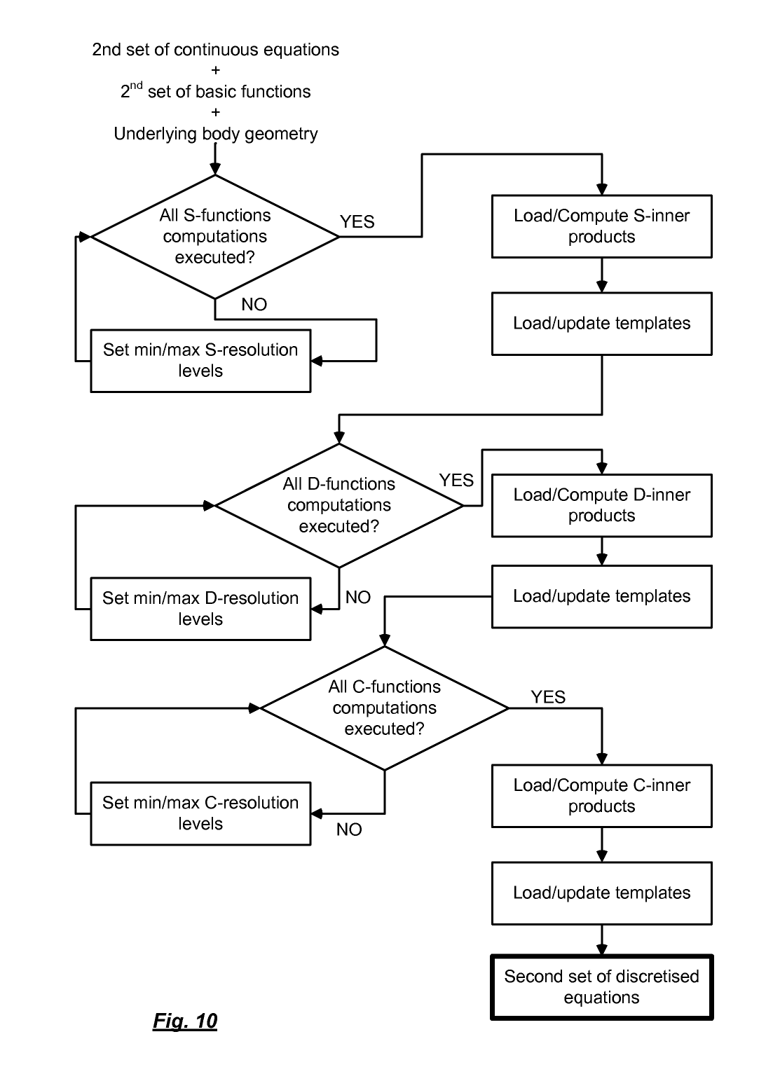

Referring to FIGS. 8 and 9, the functional steps implemented by the Discretised Equation Generator Module to generate the first set of discretised equations will now be described.

The discretised equation generator module—depending on the underlying geometry of the object to be imaged—is configured either to load a set of pre-computed integral computations (i.e. integrals of combinations of functions) that correspond to a fixed or standard geometry (e.g. a square domain or a circle of a given radius), or to perform integral computations on-the-fly for a given geometry and a set of problem specific constraints. All aforementioned integral computations are based on the first set of continuous equations.

To properly explain the teachings of the present invention, let us assume that integral computations are not loaded from a data store, but are instead computed “on-the-fly”. For notational convenience, in the following description each term that is associated with a boundary Surface of the body to be imaged will be referred to as an S-term, for example: S-function. Similarly, each term that is associated with the underlying Domain of the body to be imaged will be referred to as a D-term, for example: D-integral computations. Lastly, each term that is associated with problem specific Constraints will be referred to as a C-term, for example: C-basis function.

Referring now to FIG. 8, in a first step, the software retrieves the description of the geometry, the boundary surface of the underlying geometry and the problem specific constraints (i.e. the previously procured continuous equations and basis functions) from the data store.

Since the boundary surface of the underlying geometry is associated with a plurality of S-functions, the software executes a loop that prompts the user to assign a maximum and a minimum resolution level for each S-function. In one implementation, all S-functions could be set with the same maximum and/or minimum resolution level.

In the next step, given that a basis function has been assigned for each S-function (i.e. an S-basis function) by the Basis Function Procurement Module (FIG. 6); a set of resolution levels for each S-basis function has been defined; and the S-description of the boundary surface has been input, the software then performs all S-integral computations. In a default configuration, integral computations may be approximated with standard mid-point quadrature, as described in many calculus textbooks. In one envisaged implementation the method described in A. Kunoth, On the fast evaluation of integrals of refinable functions, in: Wavelets, Images, and Surface Fitting, Boston, 327-334, 1994, could be employed. In another implementation, the method described in H. Harbrecht and M. Randrianarivony, From Computer Aided Design to wavelet BEM, Comp. Vis. Sc. 13 (2), 69-82, 2010 could be used.

Once the integral computations have been performed, non-zero values (later identified as entries in numerical templates/matrices) along with their matrix/vector coordinates are used to update numerical S-templates. These templates are collections of common computational routines, commonly used to perform matrix-vector operations. For example, in an EIT-DEM (Electrical Impedance Tomography—Domain Embedding Method) formulation that has been configured with single-level basis functions, the integral computations along a side of a square domain attain only a few non-zero entries, in fixed locations for a fixed resolution level. In matrix form, this corresponds to a banded matrix with limited non-zero matrix-entries that are almost identical. For a desired matrix vector operation, a numerical template is set which corresponds to this matrix, and which only applies the non-zero entries of this matrix to the corresponding non-zero entries of the given vector. In one implementation, this approach significantly reduces computational operations for matrix vector products as the entire matrix is never explicitly formed or stored.

In the next step, since a plurality of D-functions are associated with the underlying geometry, the software executes a loop and prompts the user to assign a maximum and a minimum resolution level for each D-function. In one implementation, all D-function could be set with the same maximum and/or minimum resolution level.

Next, given that a basis function has been assigned for each D-function (i.e. a D-basis function) by the Basis Function Procurement Module (FIG. 6); a set of resolution levels for each D-basis function has been defined; and the D-description of the underlying domain has been input, the software then performs all D-integral computations. In a default configuration, D-integral computations may be approximated with standard mid-point quadrature, as described in many calculus textbooks. In one envisaged implementation the method described in A. Kunoth, On the fast evaluation of integrals of refinable functions, in: Wavelets, Images, and Surface Fitting, Boston, 327-334, 1994, could be employed. In another implementation, the method described in the aforementioned paper by H. Harbrecht and M. Randrianarivony could be used.

Once the integral computations have been performed, non-zero values along with their matrix/vector coordinates are used to update numerical D-templates. These templates are collections of common computational routines, commonly used to perform matrix-vector operations. For example, in an EIT-DEM formulation configured with single-level basis functions, the D-integral computations of a square domain attain only a few non-zero entries, in fixed locations for a fixed resolution level. In matrix form, this corresponds to a blocked-banded matrix with limited non-zero entries that are almost identical. For a desired matrix vector operation, a numerical D-template is set which corresponds to this matrix, and which only applies the non-zero entries of this matrix to the corresponding non-zero entries of the given vector. This approach significantly reduces computational operations for matrix-vector products as the entire matrix is never explicitly formed or stored.

In the next step, since a plurality of C-functions are associated with the underlying boundary surface, geometry and problem at hand, the software executes a loop and prompts the user to assign a maximum and a minimum resolution level for each C-function. In one envisaged implementation, all C-functions could be set with the same maximum and/or minimum resolution level.

Next, given that a basis function has been assigned for each C-function (i.e. a C-basis function) by the Basis Function Procurement Module (FIG. 6); a set of resolution levels for each C-basis function has been defined; and a C-description of the underlying domain and/or surface and/or problem constraint or specification has been defined, the software performs all C-integral computations. In a default configuration, C-integral computations are approximated with standard mid-point quadrature, as described in many calculus textbooks. In one envisaged implementation the method described in A. Kunoth, On the fast evaluation of integrals of refinable functions, in: Wavelets, Images, and Surface Fitting, Boston, 327-334, 1994, could be employed. In another implementation, the method described in the aforementioned paper by H. Harbrecht and M. Randrianarivony could be used.

In one EIT-DEM formulation, the C-functions are associated with Lagrange multipliers that impose zero current flux on the inter-electrode parts of the boundary surface as for instance in P. Kantartzis and P. Liatsis, “On Sparse Forward Solutions in Non-Stationary Domains for the EIT Imaging Problem”, IEEE EMBC, Boston, Mass., 2011. In one implementation, C-basis functions may be configured to attain lower resolution levels than the maximum resolution level of either the S- and/or D-basis functions.

Once the integral computations have been performed, non-zero values along with their matrix/vector coordinates are used to update numerical C-templates. These templates are collections of common computational routines, commonly used to perform matrix-vector operations. For example, in an EIT-DEM formulation configured with single-level basis functions, the C-integral computations along the side of a square domain attain only a few non-zero entries, in fixed locations for a fixed resolution level. In matrix form, this corresponds to a rectangular blocked-banded matrix with limited non-zero entries that are almost identical. For a desired matrix vector operation, a numerical C-template is set, which corresponds to this matrix, which only applies the non-zero entries of this matrix to the corresponding non-zero entries of the given vector. This significantly reduces computational operations for matrix-vector products as the entire matrix is never explicitly formed or stored.

Herein, when the involved functions in S-, D-, C-, integral computations (and associated templates) are part of the so called right-hand-sides (ie, given data), the associated numerical templates that would produce the right-hand-side coefficients are identified as Right Hand Sides (RHS). In addition, the software computes numerical templates for partial derivatives (or local gradients or integrals of gradients) with respect to material distribution basis functions. An illustrative EIT implementation can be found in N Polydorides, W R B Lionheart, Adjoint Formulations in Impedance Imaging, 3rd Ind. Proc. Tom., Canada, 689-694, 2003. In the sequel, such templates would be identified as PAR-templates.

Once the sets of S-, D-, and C-templates along with the associated resolution levels, RHS and PAR (partial derivative) templates have been defined, they are output by the Discretised Equation Generator Module as the first set of discretised equations.

Referring now to FIG. 9, the steps implemented by the “Load/Update templates” functions shown in FIG. 8 will now be described in more detail.

In a first step, the software checks whether the employed basis functions are of single- or multilevel configuration. For a single-level configuration, the software proceeds with updating standard single level templates for matrix-vector operations as described above. For a multi-level configuration, the software utilises the loaded multilevel transformations/operations derived by the Basis Function Procurement Module (FIG. 6) to provide numerical templates that will perform: i) a transformation from single-level to multi-level basis functions; ii) a scaling required for the multi-level basis functions; and iii) any additional multilevel computations that might be required for other computations (for example, calculations required for the evaluation of Sobolev norms using multilevel templates. Such an implementation can be found at C. Burstedde, On the Numerical Evaluation of Fractional Sobolev Norms. Comm. Pure App. An., 6(3), 587-605, 2007).

An illustrative example of the above computations can be found in: A. Kunoth, Wavelet-Based Multiresolution Methods for Stationary PDEs and PDE-Constrained Control Problems, Front. Num. An., 1-63, Springer, 2005.

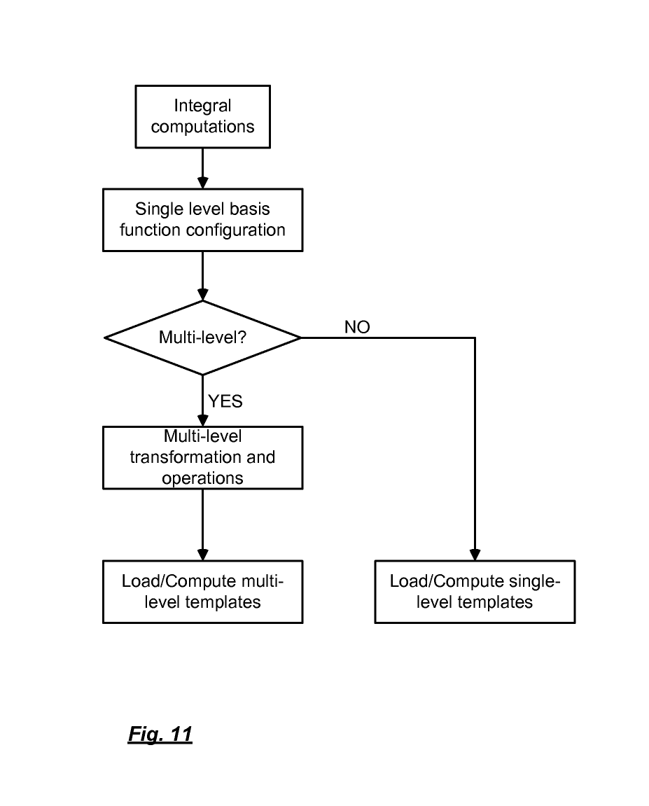

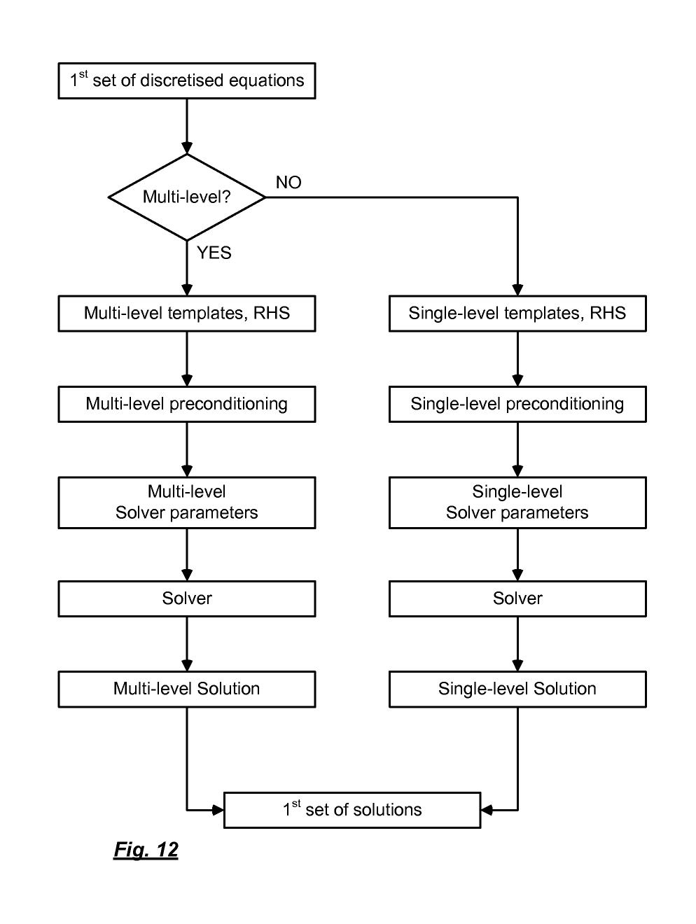

Referring to FIGS. 10 and 11, the functional steps implemented by the Discretised Equation Generator Module to generate the second set of discretised equations will now be described.

The discretised equation generator module—depending on the underlying geometry of the object to be imaged—is configured either to load a set of pre-computed integral computations (i.e. integrals of combinations of functions) that correspond to a fixed or standard geometry (e.g. a square domain or a circle of a given radius), or to perform integral computations on-the-fly for a given geometry and a set of problem specific constraints. All integral computations are based on the second set of continuous equations.

To properly explain the teachings of the present invention, let us assume that integral computations are not loaded from a data store, but are instead computed “on-the-fly”. For notational convenience, in the following description each term that is associated with a boundary Surface of the body to be imaged will be referred to as an S-term, for example: S-function. Similarly, each term that is associated with the underlying Domain of the body to be imaged will be referred to as a D-term, for example: D-integral computations. Lastly, each term that is associated with problem specific Constraints will be referred to as a C-term, for example: C-basis function.

Referring now to FIG. 10, in a first step, the software retrieves the description of the geometry, the boundary surface of the underlying geometry and the problem specific constraints (i.e. the previously procured continuous equations and basis functions) from the data store.

Since the boundary surface of the underlying geometry is associated with a plurality of S-functions, the software executes a loop that prompts the user to assign a maximum and a minimum resolution level for each S-function. In one implementation, all S-functions could be set with the same maximum and/or minimum resolution level.

In the next step, given that a basis function has been assigned for each S-function (i.e. an S-basis function) by the Basis Function Procurement Module (FIG. 7); a set of resolution levels for each S-basis function has been defined; and the S-description of the boundary surface has been input, the software then performs all S-integral computations. In a default configuration, integral computations may be approximated with standard mid-point quadrature, as described in many calculus textbooks. In one envisaged implementation the method described in A. Kunoth, On the fast evaluation of integrals of refinable functions, in: Wavelets, Images, and Surface Fitting, Boston, 327-334, 1994, could be employed. In another implementation, the method described in the aforementioned paper by H. Harbrecht and M. Randrianarivony could be used.

Once the integral computations have been performed, non-zero values along with their matrix/vector coordinates are used to update numerical S-templates. These templates are collections of common computational routines, commonly used to perform matrix-vector operations. For example, in an EIT-DEM (Electrical Impedance Tomography—Domain Embedding Method) formulation that has been configured with single-level basis functions, the integral computations along a side of a square domain attain only a few non-zero entries, in fixed locations for a fixed resolution level. In matrix form, this corresponds to a banded matrix with limited non-zero entries that are almost identical. For a desired matrix vector operation, a numerical template is set which corresponds to this matrix, and which only applies the non-zero entries of this matrix to the corresponding non-zero entries of the given vector. This approach significantly reduces computational operations for matrix vector products as the entire matrix is never explicitly formed or stored.

In the next step, since a plurality of D-functions are associated with the underlying geometry, the software executes a loop and prompts the user to assign a maximum and a minimum resolution level for each D-function. In one implementation, all D-functions could be set with the same maximum and/or minimum resolution level.

Next, given that a basis function has been assigned for each D-function (i.e. a D-basis function) by the Basis Function Procurement Module (FIG. 7); a set of resolution levels for each D-basis function has been defined; and the D-description of the underlying domain has been input, the software then performs all D-integral computations. In a default configuration, D-integral computations may be approximated with standard mid-point quadrature, as described in many calculus textbooks. In one envisaged implementation the method described in A. Kunoth, On the fast evaluation of integrals of refinable functions, in: Wavelets, Images, and Surface Fitting, Boston, 327-334, 1994, could be employed. In another implementation, the method described in the aforementioned paper by H. Harbrecht and M. Randrianarivony could be used.

Once the integral computations have been performed, non-zero values along with their matrix/vector coordinates are used to update numerical D-templates. These templates are collections of common computational routines, commonly used to perform matrix-vector operations. For example, in an EIT-DEM formulation configured with single-level basis functions, the D-integral computations of a square domain attain only a few non-zero entries, in fixed locations for a fixed resolution level. In matrix form, this corresponds to a blocked-banded matrix with limited non-zero entries that are almost identical. For a desired matrix vector operation, a numerical D-template is set which corresponds to this matrix, and which only applies the non-zero entries of this matrix to the corresponding non-zero entries of the given vector. This approach significantly reduces computational operations for matrix-vector products as the entire matrix is never explicitly formed or stored.

In the next step, since a plurality of C-functions are associated with the underlying boundary surface, geometry and problem at hand, the software executes a loop and prompts the user to assign a maximum and a minimum resolution level for each C-function. In one envisaged implementation, all C-functions could be set with the same maximum and/or minimum resolution level.

Next, given that a basis function has been assigned for each C-function (i.e. a C-basis function) by the Basis Function Procurement Module (FIG. 7); a set of resolution levels for each C-basis function has been defined; and a C-description of the underlying domain and/or surface and/or problem constraint or specification has been defined, the software performs all C-integral computations. In a default configuration, C-integral computations are approximated with standard mid-point quadrature, as described in many calculus textbooks. In one envisaged implementation the method described in A. Kunoth, On the fast evaluation of integrals of refinable functions, in: Wavelets, Images, and Surface Fitting, Boston, 327-334, 1994, could be employed. In another implementation, the method described in the aforementioned paper by H. Harbrecht and M. Randrianarivony could be used.

In one EIT-DEM formulation, the C-functions are associated with Lagrange multipliers that impose zero current flux on the inter-electrode parts of the boundary surface as for instance in P. Kantartzis and P. Liatsis, “On Sparse Forward Solutions in Non-Stationary Domains for the EIT Imaging Problem” IEEE EMBC, Boston, Mass., 2011. In one implementation, C-basis functions may be configured to attain lower resolution levels than the maximum resolution level of either the S- and/or D-basis functions.

Once the integral computations have been performed, non-zero values along with their matrix/vector coordinates are used to update numerical C-templates. These templates are collections of common computational routines, commonly used to perform matrix-vector operations. For example, in an EIT-DEM formulation configured with single-level basis functions, the C-integral computations along the side of a square domain attain only a few non-zero entries, in fixed locations for a fixed resolution level. In matrix form, this corresponds to a rectangular blocked-banded matrix with limited non-zero entries that are almost identical. For a desired matrix vector operation, a numerical C-template is set, which corresponds to this matrix, which only applies the non-zero entries of this matrix to the corresponding non-zero entries of the given vector. This significantly reduces computational operations for matrix-vector products as the entire matrix is never explicitly formed or stored.

Herein, when the involved functions in S-, D-, C-, integral computations (and associated templates) are part of the so called right-hand-sides (ie, given data), the associated numerical templates that would produce the right-hand-side coefficients are identified as Right Hand Sides (RHS). In one implementation, the assembly of the RHS is based on the structure of the measurement operator (which is application depended and loaded from a data store) to be described in property extraction module (functional step 19 (FIG. 3)). In addition, the software computes numerical templates for partial derivatives (or local gradients or integrals of gradients) with respect to material distribution basis functions. An illustrative EIT implementation can be found in N Polydorides, W R B Lionheart, Adjoint Formulations in Impedance Imaging 3rd Ind. Proc. Tom., Canada, p 689-694, 2003. In the sequel, such templates would be identified as PAR-templates.

Once the sets of S-, D-, and C-templates along with the associated resolution levels, RHS and PAR (partial derivative) templates have been defined, they are output by the Discretised Equation Generator Module as the first set of discretised equations.

Referring now to FIG. 11, the steps implemented by the “Load/Update templates” functions shown in FIG. 10 will now be described in more detail.

In a first step, the software checks whether the employed basis functions are of single- or multilevel configuration. For a single-level configuration, the software proceeds with updating standard single level templates for matrix-vector operations as described above.

For a multi-level configuration, the software utilises the loaded multilevel transformations/operations derived by the Basis Function Procurement Module (FIG. 7) to provide numerical templates that will perform: i) a transformation from single-level to multi-level basis functions; ii) a scaling required for the multi-level basis functions; and iii) any additional multilevel computations that might be required for other computations (for example, calculations required for the evaluation of Sobolev norms using multilevel templates. Such an implementation can be found at C. Burstedde, On the Numerical Evaluation of Fractional Sobolev Norms. Comm. Pure App. An. 6(3) 587-605, 2007).

An illustrative example of the above computations can be found in: A. Kunoth, Wavelet-Based Multiresolution Methods for Stationary PDEs and PDE-Constrained Control Problems, Front. Num. An., 1-63, Springer, 2005,

Referring to FIGS. 12 to 17, the functional steps 15, 17 (FIG. 3) implemented by the Equation Solver Module to generate the first and second sets of solutions will now be described.

Referring to FIG. 12, the Equation Solver Module is provided with the numerical templates that form the 1^{st} set of discretised equations, and determines whether those equations are single or multi-level equations. To properly explain the teachings of the present invention, let us first assume that the templates of the first set of discretised equations are multi-level.

In a default configuration, multilevel templates are used to form the so-called right hand sides (RHS) and so-called diagonal preconditioning. An EIT implementation of such a default configuration can be found in P. Kantartzis, A. Kunoth, R, Pabel and P. Liatsis, “Wavelet preconditioning for EIT”, ICEBI 2010. Next, the software loads a set of default solver parameters. In one implementation, a tolerance level is set to no more than 100 times a minimum discretisation pitch of the S-, D- or C-basis functions (it being understood that for each discretisation level of S-, D- and C-basis functions there exists an S-, D- and C-discretisation step that is commonly referred to in the literature as the “pitch”). In one implementation the maximum number of iterations is set to no more than half the length of the RHS (in round numbers) (it being appreciated by persons of ordinary skill in the art that the RHS are formed by sets of vectors, where each vector holds a variable length size which is determined by the S-, D- or C-discretisation levels).

Minimum levels (coarsest level) for the multilevel numerical templates and the diagonal preconditioning scheme are also set. In one implementation all levels are set to 3.

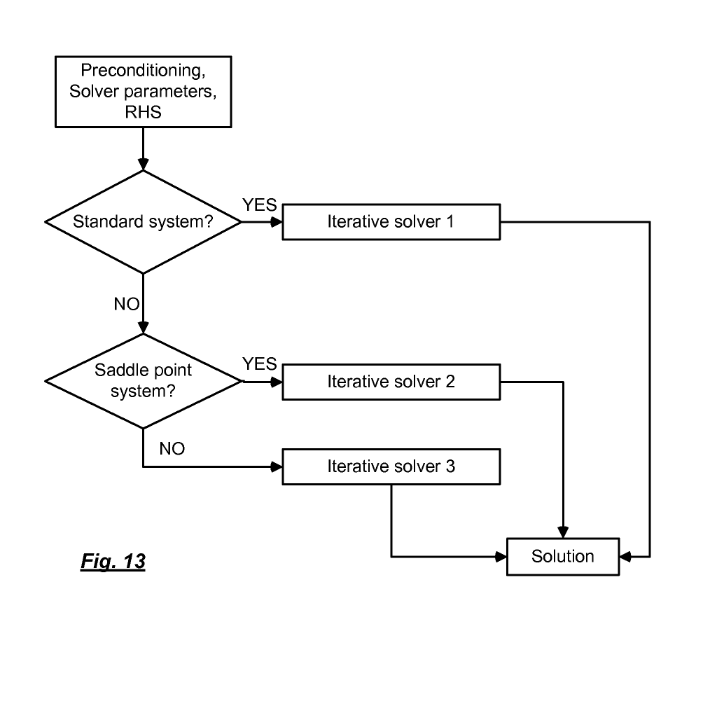

Next, the multilevel templates, the RHS, the multi-level preconditioning and the multilevel parameters are fed to the solver module (shown in FIG. 13) and a set of multi-level solutions for the various RHS is produced.

Referring to FIG. 13, in a first step the software identifies the S-, D-, C-, templates, ie, the system matrix numerical template. If the numerical template corresponds to a standard symmetric and positive definite system matrix, the software adopts iterative solver 1 as the solver of choice. In one implementation, iterative solver 1 is a conjugate gradient solver, and in another implementation iterative solver 1 is a bi-conjugate gradient solver. In one implementation, the iterative solver 1 is configured to be a multigrid solver, akin to multigrid-type methods described in W. Hackbusch, Multi-Grid Methods and Applications Series, Springer, 1985. In one implementation the default parameters are set to one pre- and post-smoothing step, V-cycle; and the minimum level to which the system is solved is set to 3. In one implementation the minimum level solver is configured with a QR decomposition/solution scheme.

If not, the software checks whether the numerical template which corresponds to the system matrix falls into the so called saddle point case. If this is the case, the software adopts iterative solver 2 as the solver of choice. In one implementation, iterative solver 2 may be an Uzawa iteration solver. Such a solver may be configured with a conjugate gradient solver, or a bi-conjugate gradient solver. In one implementation, the Uzawa solver may be configured with a set of multigrid solvers, akin to multigrid-type methods described in W. Hackbusch, Multi-Grid Methods and Applications Series, Springer, 1985. In one implementation the default parameters are set to one pre- and post-smoothing step, V-cycle; and the minimum level to which the system is solved is set to 3. In one implementation the minimum level solver is configured with a QR decomposition/solution scheme.

If the numerical template does not fall into the saddle point case, the software adopts iterative solver 3 as the solver of choice, and a set of solutions is produced. In one implementation, iterative solver 3 is a generalised minimum residual solver. Implementation details for each of the aforementioned iterative solvers can be found in D. Braess, Finite Elements: Theory, Fast Solvers, and Applications in Solid Mechanics, Cambridge University Press, 2007 and similar textbooks.

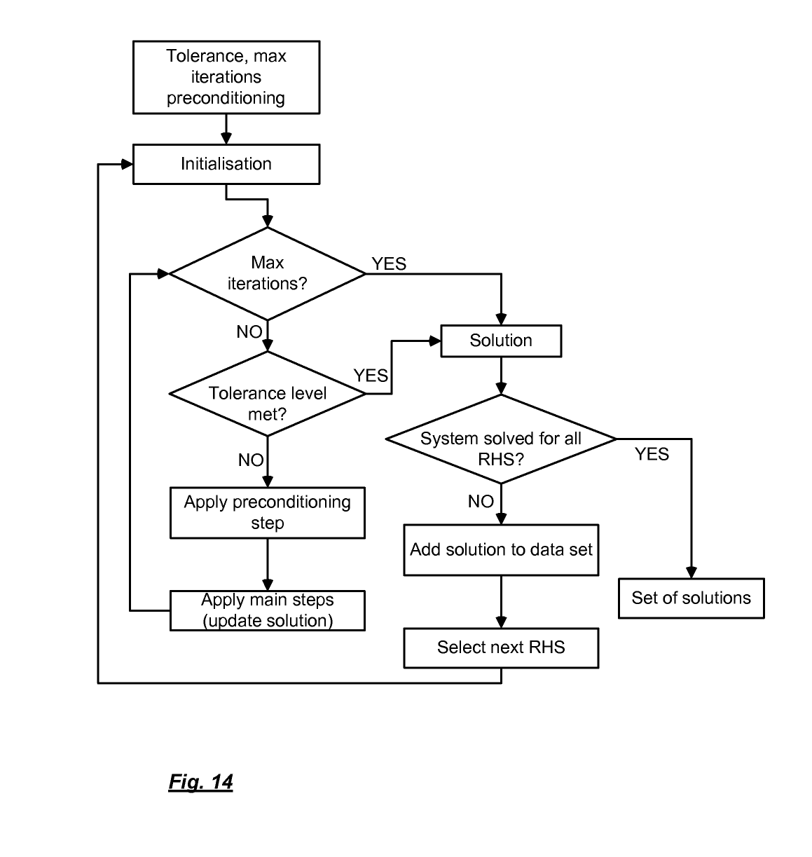

To properly explain the teachings of the present invention, the iterative solver technique (employed by each of the aforementioned solvers) will now be explained in more detail with reference to FIG. 14.

In a first step, the Equation Solver Module parses the input parameters (tolerance, preconditioning, etc) and initialises the solver. In one implementation of the initialisation process, the solver configures a zero initial vector as a temporary solution. In another implementation of the initialisation process, the solver adopts a single preconditioning step, which step could be either single-level or multi-level (“Preconditioning”, as found in most iterative solver textbooks, is a numerical transformation that improves the numerical characteristics of the system to be solved (or in other words, a preconditioning operator improves convergence in iterative solvers)). Since a plurality of iterations are typically encountered in iterative schemes, the solution steps are configured in a loop until either the maximum number of iterations is reached or the tolerance level is met.

Next, the solver applies another preconditioning step and a solver-specific solution update step. In a multilevel preconditioning configuration, the preconditioning templates are applied to the system matrix templates D-, S-, C- in order to improve the conditioning of the numerical system to be solved and to reduce the number of iterations. Since a plurality of RHS are encountered, the software is configured to execute a loop until the system matrix is solved for all given RHS, where at each step a newly determined solution is stored and the system is solved for the next RHS. An illustrative EIT implementation for the multilevel set of solutions can be found in P. Kantartzis, A. Kunoth, R, Pabel and P. Liatsis, “Multi-scale interior potential approximation for EIT”, EIT 2011, Bath, UK. In one envisaged implementation, one can implement a compression of the multi-level solution by discarding solution coefficients of absolute value smaller than a prescribed threshold parameter, for example 1e-8.

Once the system has been solved for all RHS, the software outputs a set of solutions.

Referring again to FIG. 12, now let us assume that the templates of the first set of discretised equations are single-level.

In a default configuration, the single-level templates are used to form the so called right hand sides (RHS) and the single-level preconditioning. An illustrative EIT implementation of such a default configuration can be found in M. Soleimani C. E. Powell N. Polydorides, IEEE Trans. Med. Imag., 24 (5), 577-583, 2005. Next, the software loads default solver parameters. In one implementation a tolerance level is set to no more than 100 times the minimum discretisation pitch of either the domain or boundary pitches. In one implementation, the maximum number of iterations is set to no more than half the size of the unknowns. For a single-scale of preconditioning, akin to multigrid-type methods described in W. Hackbusch, Multi-Grid Methods and ApplicationsSeries, Springer, 1985, a multigrid preconditioning is employed. In one implementation the default parameters are set to one pre- and post-smoothing step, V-cycle; and the minimum level to which the system is solved is set to 3. In one implementation the minimum level solver is configured with a QR decomposition/solution scheme.

Next, the single-level templates, the RHS, the single-level preconditioning and the single-level parameters are fed to the solver module (shown in FIG. 13) and a set of single-level solutions for the various RHS is produced. An illustrative EIT implementation for the single-level set of solutions can be found in P. Kantartzis, A. Kunoth, R. Pabel and P. Liatsis, “Single-scale interior potential approximation for EIT”, EIT 2011, Bath, UK.

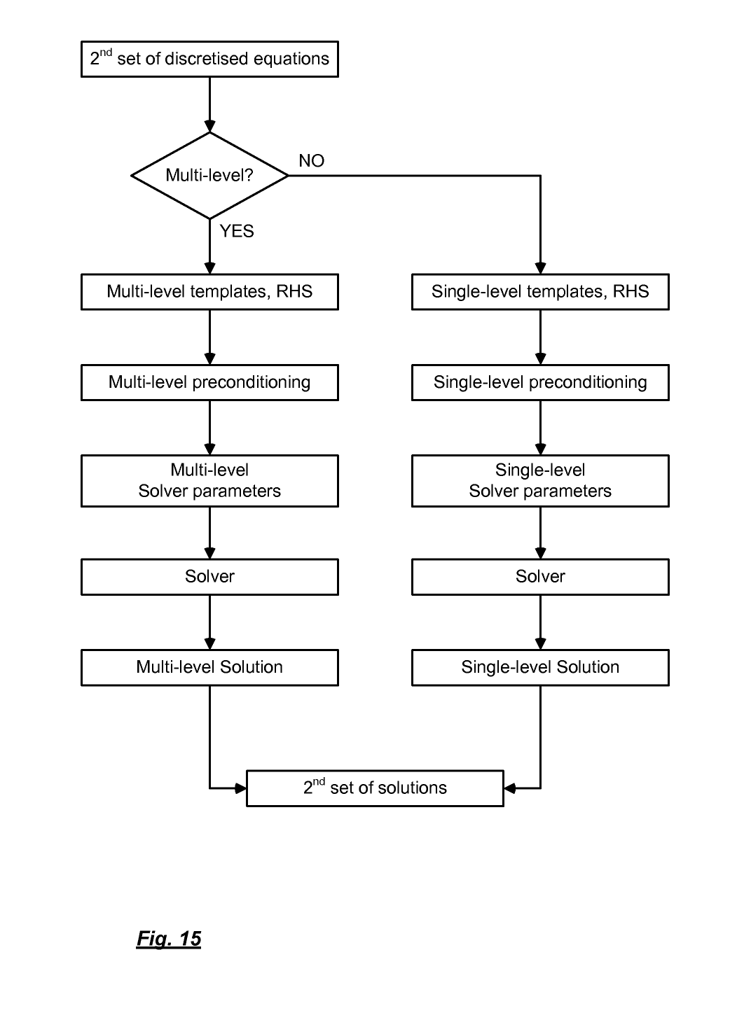

Referring to FIG. 15, the Equation Solver Module is provided with the numerical templates that form the 2nd set of discretised equations, and determines whether those equations are single or multi-level equations. To properly explain the teachings of the present invention, let us first assume that the templates of the second set of discretised equations are multi-level.

In a default configuration, multilevel templates are used to form the so-called right hand sides (RHS) and so-called diagonal preconditioning. An EIT implementation of such a default configuration can be found in P. Kantartzis, A. Kunoth, R, Pabel and P. Liatsis, “Wavelet preconditioning for EIT”, ICEBI 2010. In one implementation, the assembly of the RHS is based on the structure of the measurement operator (which is application depended and loaded from a datastore) to be described in property extraction module (functional step 19 (FIG. 3)). Next, the software loads a set of default solver parameters. In one implementation, a tolerance level is set to no more than 100 times a minimum discretisation pitch of the S-, D- or C-basis functions (it being understood that for each discretisation level of S-, D- and C-basis functions there exists an S-, D- and C-discretisation step that is commonly referred to in the literature as the “pitch”). In one implementation, the maximum number of iterations is set to no more than half the length of the RHS (in round numbers) (it being appreciated by persons of ordinary skill in the art that the RHS are formed by sets of vectors, where each vector holds a variable length size which is determined by the S-, D- or C-discretisation levels).

Minimum levels (coarsest level) for the multilevel numerical templates and the diagonal preconditioning scheme are also set. In one implementation all levels are set to 3.

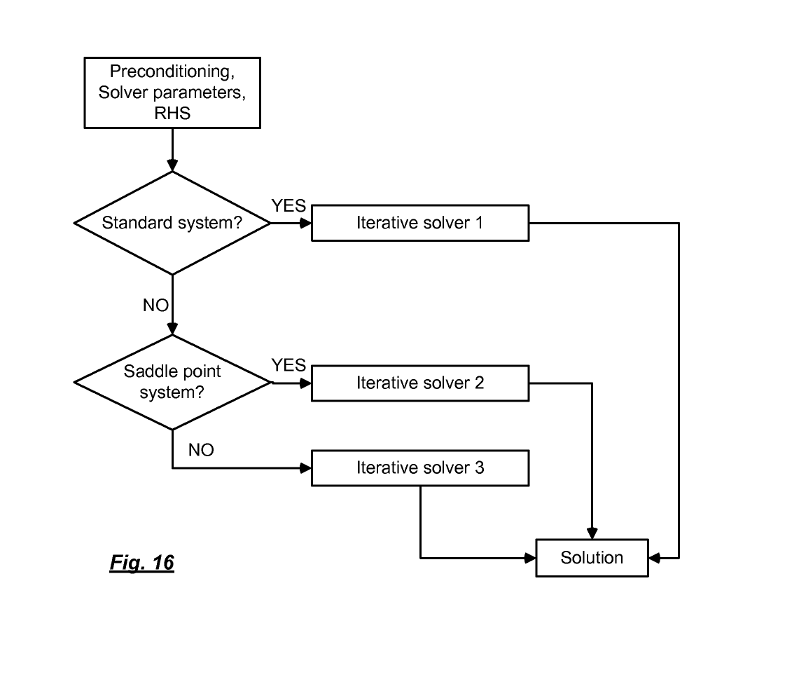

Next, the multilevel templates, the RHS, the multi-level preconditioning and the multilevel parameters are fed to the solver module (shown in FIG. 16) and a set of multi-level solutions for the various RHS is produced.

Referring to FIG. 16, in a first step the software identifies the S-, D-, C-, templates, ie, the system matrix numerical template. If the numerical template corresponds to a standard symmetric and positive definite system matrix, the software adopts iterative solver 1 as the solver of choice. In one implementation, iterative solver 1 is a conjugate gradient solver, and in another implementation iterative solver 1 is a bi-conjugate gradient solver. In one implementation, iterative solver 1 is a multigrid solver, akin to multigrid-type methods described in W. Hackbusch, Multi-Grid Methods and ApplicationsSeries, Springer, 1985. In one implementation the default parameters are set to one pre- and post-smoothing step, V-cycle; and the minimum level to which the system is solved is set to 3. In one implementation the minimum level solver is configured with a QR decomposition/solution scheme.

If not, the software checks whether the numerical template which corresponds to the system matrix falls into the so called saddle point case. If this is the case, the software adopts iterative solver 2 as the solver of choice. In one implementation, iterative solver 2 may be an Uzawa iteration solver. Such a solver may be configured with a conjugate gradient solver, or a bi-conjugate gradient solver. In one implementation, the Uzawa solver may be configured with a set of multigrid solvers, akin to multigrid-type methods described in W. Hackbusch, Multi-Grid Methods and ApplicationsSeries, Springer, 1985. In one implementation the default parameters are set to one pre- and post-smoothing step, V-cycle; and the minimum level to which the system is solved is set to 3. In one implementation the minimum level solver is configured with a QR decomposition/solution scheme.

If the numerical template does not fall into the saddle point case, the software adopts iterative solver 3 as the solver of choice, and a set of solutions is produced. In one implementation, iterative solver 3 is a generalised minimum residual solver. Implementation details for each of the aforementioned iterative solvers can be found in D. Braess, Finite Elements: Theory, Fast Solvers, and Applications in Solid Mechanics, Cambridge University Press, 2007 and similar textbooks.

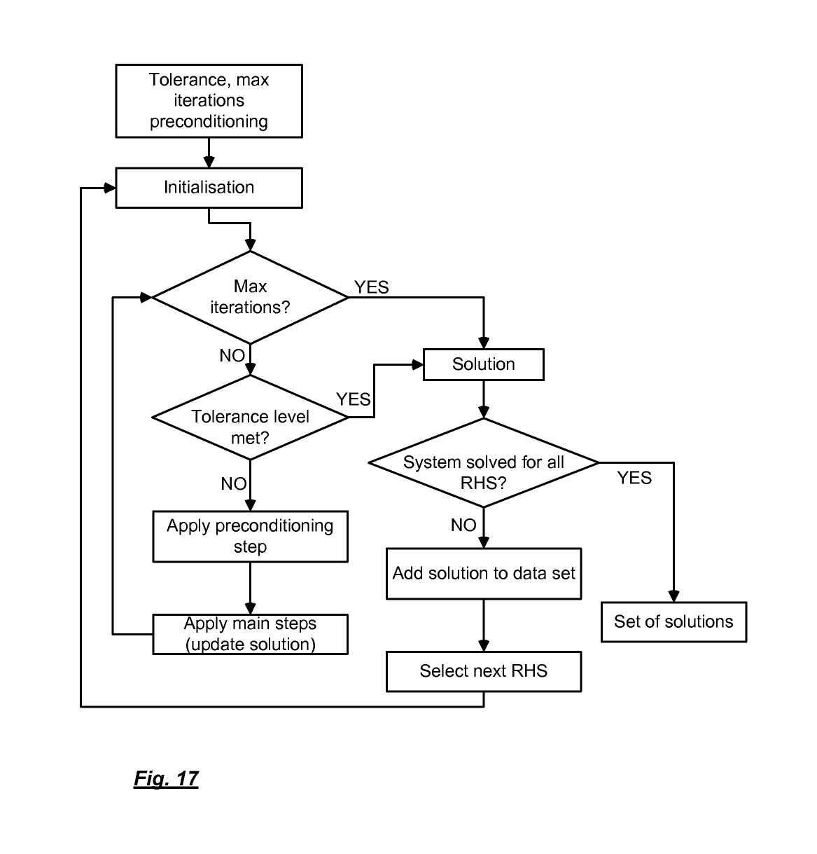

To properly explain the teachings of the present invention, the iterative solver technique (employed by each of the aforementioned solvers) will now be explained in more detail with reference to FIG. 17.

In a first step, the Equation Solver Module parses the input parameters (tolerance, preconditioning, etc) and initialises the solver. In one implementation of the initialisation process, the solver configures a zero initial vector as a temporary solution. In another implementation of the initialisation process, the solver adopts a single preconditioning step, which step could be either single-level or multi-level (“Preconditioning”, as found in most iterative solver textbooks, is a numerical transformation that improves the numerical characteristics of the system to be solved (or in other words, a preconditioning operator improves convergence in iterative solvers)). Since a plurality of iterations are typically encountered in iterative schemes, the solution steps are configured in a loop until either the maximum number of iterations is reached or the tolerance level is met.

Next, the solver applies another preconditioning step and a solver-specific solution update step. In a multilevel preconditioning configuration, the preconditioning templates are applied to the system matrix templates D-, S-, C- in order to improve the conditioning of the numerical system to be solved and to reduce the number of iterations. Since a plurality of RHS are encountered, the software is configured to execute a loop until the system matrix is solved for all given RHS, where at each step a newly determined solution is stored and the system is solved for the next RHS. An illustrative EIT implementation for the multilevel set of solutions can be found in P. Kantartzis, A. Kunoth, R, Pabel and P. Liatsis, “Multi-scale interior potential approximation for EIT”, EIT 2011, Bath, UK. In one envisaged implementation, one can implement a compression of the multi-level solution by discarding solution coefficients of absolute value smaller than a prescribed threshold parameter, for example 1e-8.

Once the system has been solved for all RHS, the software outputs a set of solutions.

Referring again to FIG. 15, now let us assume that the templates of the second set of discretised equations are single-level.

In a default configuration, the single-level templates are used to form the so called right hand sides (RHS) and the single-level preconditioning. M. Soleimani C. E. Powell N. Polydorides, IEEE Trans. Med. Imag., 24 (5), 577-583, 2005. Next, the software loads default solver parameters. In one implementation the tolerance level is set to no more that 100 times the minimum discretisation pitch of either the domain or boundary pitches. In one implementation the maximum number of iterations is set to no more than half the size of the unknowns. For a single scale multigrid-type of preconditioning akin to multigrid-type methods described in W. Hackbusch, Multi-Grid Methods and Applications Series, Springer, 1985 is employed. In one implementation the default parameters are set to one pre- and post-smoothing step, V-cycle; and the minimum level to which the system is solved is set to 3. In one implementation the minimum level solver is configured with a QR decomposition/solution scheme.

Next, the single-level templates, the RHS, the single-level preconditioning and the single-level parameters are fed to the solver module (shown in FIG. 13) and a set of single-level solutions for the various RHS is produced. An illustrative EIT implementation for the single-level set of solutions can be found in P. Kantartzis, A. Kunoth, R. Pabel and P. Liatsis, “Single-scale interior potential approximation for EIT”, EIT 2011, Bath, UK.

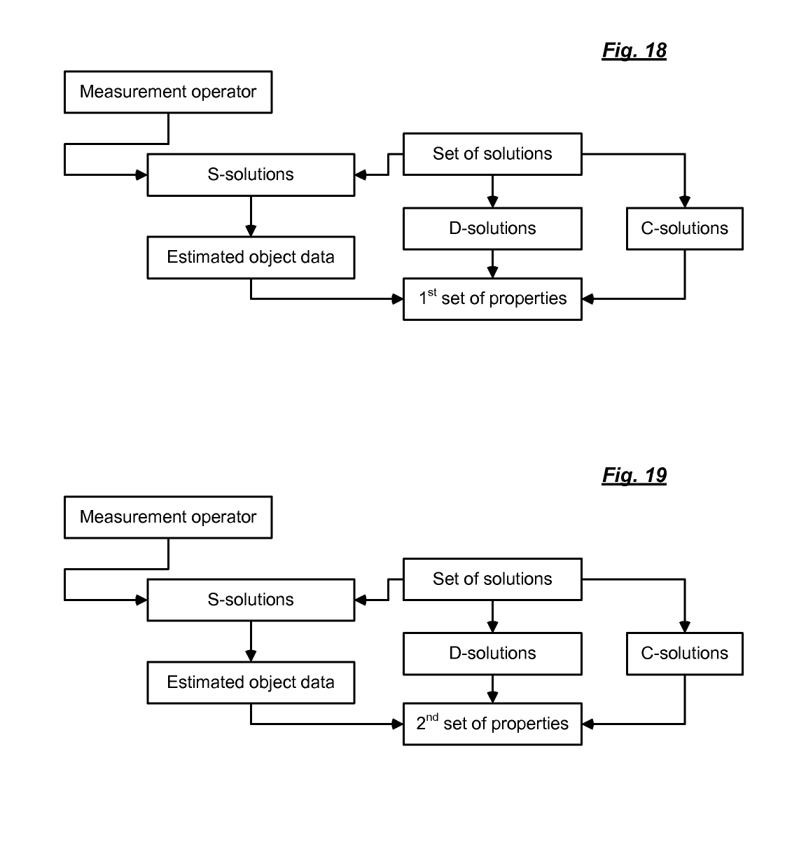

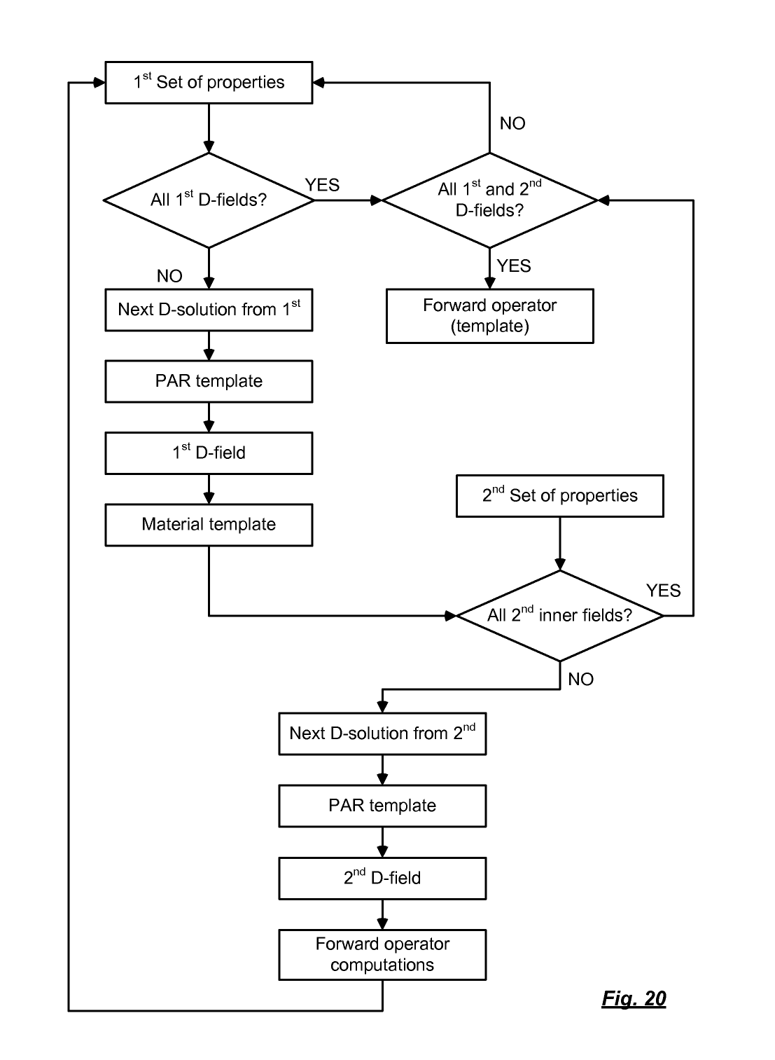

Referring to FIGS. 18 and 19, the functional steps 19, 21 (FIG. 3) implemented by the Property Extraction Module to generate the first and second sets of properties will now be described.

Referring now to FIG. 18, the Property Extraction Module employs a set of measurement operators that vary with the particular imaging task at hand to acquire object data. The measurement operators employed by the Property Extraction Module are application specific, and are loaded from a data store.

In a first step, the Property Extraction Module, based on the D-, S- and C-numerical templates, extracts the D-, S- and C-compartments of the solution data set, i.e. the D-solutions, S-solutions and C-solutions.

In the next step, a measurement operator is applied to the S-solution to estimate object data. In one implementation, the measurement operator comprises a differential operator, for example a first order Laplacian operator. In one implementation the application of the measurement operator to the S-solutions may comprise a multiplication of a matrix with each of the S-solutions, thereby, forming a set of estimated object data. In one implementation, estimated object data in vector form may comprise a concatenation of the various multiplications of the Laplacian operator with each of the S-solutions. It is envisaged that in one implementation the measurement operator is employed to form the RHS template of the 2^{nd} set of Discretised equations by means of the so called adjoint fields method described. An EIT implementation can be found in N Polydorides, W R B Lionheart, Adjoint Formulations in Impedance Imaging, 3rd Ind. Proc. Tom., Canada, 689-694, 2003. The set of D-solutions, estimated object data and C-solutions are output by the Property Extraction Module as the 1^{st} set of properties.

Referring now to FIG. 19, the Property Extraction Module employs a set of measurement operators that vary with the particular imaging task at hand to acquire object data. The measurement operators employed by the Property Extraction Module are application specific, and are loaded from a data store.

In a first step, the Property Extraction Module, based on the D-, S- and C-numerical templates, extracts the D-, S- and C-compartments of the solution data set, i.e. the D-solutions, S-solutions and C-solutions.

In the next step, a measurement operator is applied to the S-solution to estimate object data. In one implementation, the measurement operator comprises a differential operator, for example a first order Laplacian operator. In one implementation the application of the measurement operator to the S-solutions may comprise a multiplication of a matrix with each of the S-solutions, thereby, forming a set of estimated object data. In one implementation, estimated object data in vector form may comprise a concatenation of the various multiplications of the Laplacian operator with each of the S-solutions.

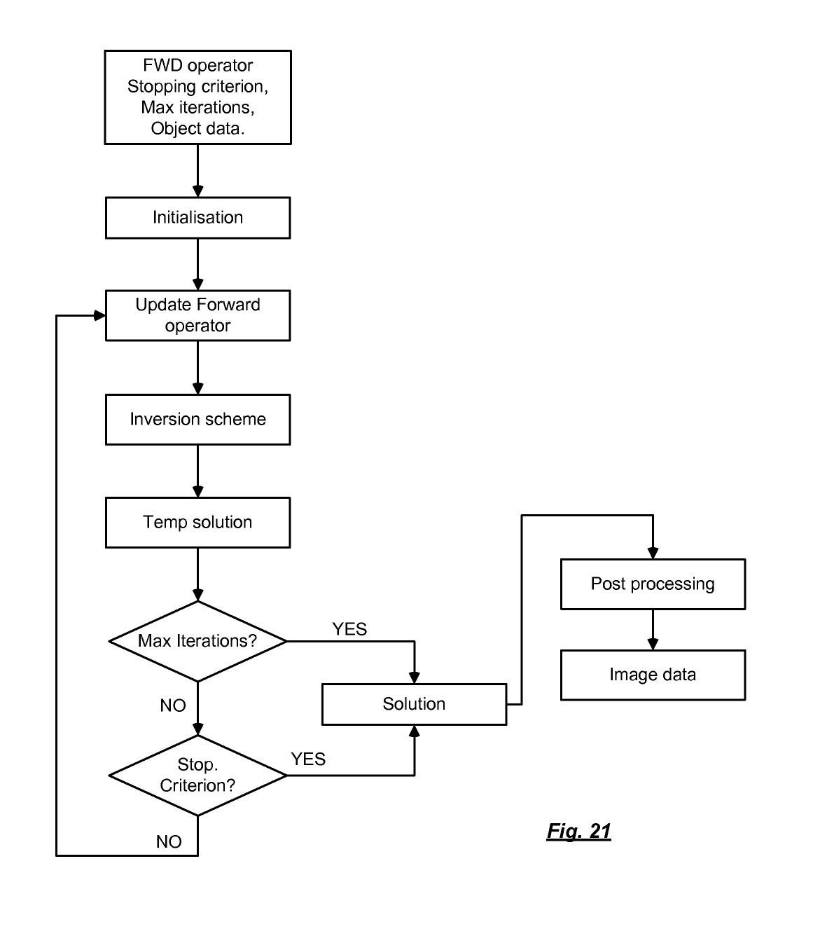

Referring to FIG. 20, the functional step 23 (FIG. 3) implemented by the Operator Generator Module to generate the forward operator will now be described. As will now be described, the operator generator module employs the aforementioned 1^{st} set of properties along with the aforementioned 2^{nd} set of properties to generate a forward operator.

In a first step, a first D-solution is selected from the 1^{st} set of properties provided by the Property Extraction Module. The PAR-template (generated by the Discretised Equation Generator) is then applied to a first D-solution (generated by the Property Extraction Module) to generate a first D-field. In one implementation, the PAR-template comprises a collection of local gradient operators (where the term “local” means an operator that is non-zero on a specific neighbourhood defined from the characteristics of the basis function assigned to the material distribution and generated from the basis function output by the Basis Function Procurement Module; and the “gradient” is a mathematical operator), i.e.—a local PAR-template.

In one implementation, the neighbourhood (for the local PAR-template) is configured to be the non-zero support of the local partial-derivative with respect to the local material distribution. In an EIT implementation, the D-solution comprises an interior potential distribution.

In a following step, the local gradient operator (ie, local-PAR template) is applied to a D-solution to produce a D-field. In an EIT implementation, the application of the local gradient operator (i.e. local-PAR template) to the interior potential distribution produces an electric field. Depending on the application task at hand, the D-field is weighted by the local-material distribution template.

In an EIT implementation, a piece-wise constant basis functions is generated in the basis function generation module and employed in the discretised equation module to form the material distribution D-template (i.e. conductivity). An illustrative implementation can be found in N Polydorides, W R B Lionheart, Adjoint Formulations in Impedance Imaging, 3rd Ind. Proc. Tom., Canada, 689-694, 2003. In one implementation, a piece-wise constant basis functions could be a Haar basis function.

In a following step, a first D-solution is selected from the second set of properties. The local PAR-template is then applied to a first D-solution from the second set of solutions to generate a first D-field. In one implementation, the PAR-template is a collection of local gradient (as previously defined) operators.

In one implementation, the neighbourhood (for the local PAR template) is configured to be the non-zero support of the local partial-derivative with respect to the local material distribution. In an EIT implementation, the generated D-field comprises the so called adjoint field. In an EIT implementation, the application of the local-PER template to an interior potential distribution produces an electric field, i.e. a D-field.

The material template along with the D-fields from the first set of properties and the D-fields from the second set of properties are iteratively employed in conjunction with the PAR-template to form a forward operator. In one implementation the assembly of the forward operator is achieved in a row-by-row fashion. In one implementation, this is achieved by pointwise multiplication of the D-fields as they become available in the loop process. In another implementation the assembly of the forward operator is achieved in an element-by-element fashion (i.e. entry-by-entry assembly). An example of the assembly of the forward operator for the MIT (Magnetic Induction Tomography) case can be found in W R B Lionheart, M Soleimani, A J Peyton, Sensitivity Analysis of 3D Magnetic Induction Tomography (MIT), Proc. 3rd World Cong. Ind. Proc. Tomogr. p 239-244, 2003. In one implementation, the forward operator along with its complex and/or real transpose could be assembled in a matrix free fashion, using numerical templates. A fluorescence imaging example of the assembly of the forward operator can be found in Athanasios Zacharopoulos et al, Development of in-vivo fluorescence imaging with the Matrix-Free method J. Phys.: Conf. Ser. 255 012006, 2010.

Since a plurality of first and second sets of properties are typically encountered, the software implements the aforementioned functionality in a loop. In one implementation, if the 1^{st} and 2^{nd} set of properties are of single-level nature, (i.e. single-level solutions generated in functional steps 15, 17) the forward operator is said to be a single-level forward operator. An example of the assembly of the single-level forward operator can be found in P. Kantartzis, Multi-level soft-field tomography, PhD thesis, City University London, UK, 2011.

In one implementation, if the 1^{st} and 2^{nd} set of properties are of multi-level nature (i.e. multi-level solutions generated in functional steps 15, 17), the forward operator is said to be a multi-level forward operator. An example of the assembly of the multi-level forward operator can be found in P. Kantartzis, Multi-level soft-field tomography, PhD thesis, City University London, UK, 2011.

In one multi-level implementation of the forward operator, the D-solutions are filtered to discard entries of absolute value smaller than a specific threshold. In one implementation, this threshold is configured as the noise level in object data provided by the instrument that acquired the object data. In one multi-level implementation of the forward operator, the threshold value for the D-solutions is configured to be manually settable by the user.

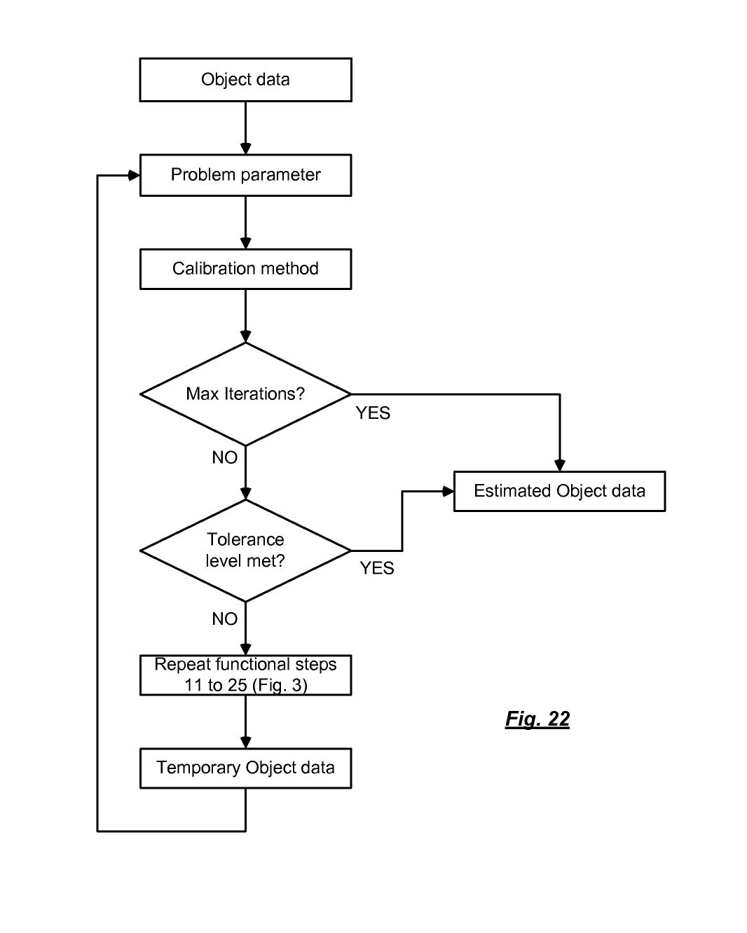

Referring to FIG. 21, the functional step 25 implemented by the image generator module to generate image data will now be described. As will now be described, the image generator module is provided with object data (from the object being imaged), and uses the above described forward operator template to generate image data. In a default state, which is retrieved from the equation procurement module, image reconstruction is set to difference imaging (see also FIG. 4).

In a first step, the image generator module is initialised and loads, for example from a data store, a set of image generation preferences. In one envisaged implementation, the image generation preferences comprise: a variable indicating the maximum number of iterations; a tolerance level; a so-called stopping criterion; an inversion scheme; and an initial approximation for the material distribution of the object being imaged.

Next, an inversion scheme is employed to generate a temporary solution, i.e. a temporary material distribution, that is then used to update the forward operator template. This update is formed by repeating the above described functional steps 11 to 23 (FIG. 3) using the new (temporary) material distribution. The software is configured to complete a plurality of iterations until either the maximum number of iterations or the stopping criterion is met. The resulting solution, referred to as an inverse solution, is then subjected to post-processing.

In one envisaged implementation, post-processing comprises a mapping of the inverse solution to a square grid. In another implementation, post-processing additionally comprises a deconvolution task that aims to provide a sharper image. One illustrative implementation of a suitable deconvolution task can be found in C. Vonesch, M. Unser, “A Fast Multilevel Algorithm for Wavelet-Regularized Image Restoration,” IEEE Transactions on Image Processing, vol. 18, no. 3, pp. 509-523, 2009. Post-processing of the inverse solution forms a set of image data for display to an operator.

In one implementation of the initialisation step, the initial guess for the material distribution may be configured to zero. In other implementations, the image generation preferences could be manually set by the user.

In an envisaged arrangement, the stopping criterion interrupts (stops) the iterative algorithms when the tolerance level falls below a predetermined measurement noise level (said level being set by the manufacturer of the particular data acquisition device being used), i.e. the so-called Morozov's stopping criterion.

In one implementation where a single level forward operator is used, a single-level inversion scheme is employed which produces a single-level material distribution. In another implementation where a multi-level forward operator is used, a multi-level inversion scheme is employed which produces a multi-level material distribution. In one implementation, the multi-level material distribution may be filtered to discard entries of absolute value smaller than a specific threshold. In one implementation, this threshold is configured as being equal to a noise level in object data provided by the device that acquired the object data. In one multi-level implementation of the forward operator (operator generator module), the threshold value for the D-solutions may be manually set by the user.

In one implementation the inversion scheme comprises a linear-inversion scheme based on Tikhonov regularisation principles. In one implementation based on the Tikhonov regularisation principles, the parameters for the linear inversion scheme are the regularisation matrix and the regularisation parameter. In one implementation, the regularisation parameter is determined by the classical L-curve method and the regularisation matrix is a first order Laplacian operator.

In another implementation a non-linear inversion scheme may be employed. For example the non-linear inversion scheme may comprise the Thresholded Landweber Iteration (TLI), an illustrative implementation of which can be found in C. Vonesch, M. Unser, “A Fast Multilevel Algorithm for Wavelet-Regularized Image Restoration,” IEEE Transactions on Image Processing, vol. 18, no. 3, pp. 509-523, 2009. Another illustrative TLI implementation can be found in M. Gehre, T. Kluth, A. Lipponen, B. Jin, A. Seppanen, J. Kaipio, P. Maass. Sparsity reconstruction in electrical impedance tomography: an experimental evaluation. J. Comp. App. Math, 236(8), 2126-2136, 2012.

Referring to FIG. 22, the functional step 27 (FIG. 3) implemented by the calibration module to calibrate a problem parameter will now be described. In general terms, the calibration module adjusts the problem parameter until estimated object data is within a predetermined tolerance level of with measured object data from the body being examined.

In a first step, the software loads from a data store a default problem parameter and a calibration method, a default number of maximum iterations and a default level of tolerance. The calibration method is operable to adjust the problem parameter, which problem parameter is the fed to the Discretised Equation Generator Module. The software repeats functional steps 11 to 25 (FIG. 3) and generates a set of temporary object data. Since a plurality of calibration iterations are typically encountered, the software implements the aforementioned functionality in a loop until the measured difference between the object data and the temporary object data is less than the previously determined the level of tolerance (which tolerance may be measured in the error L2-sense).

In one illustrative implementation, the aforementioned problem parameter may comprise the S-boundary surface, and the calibration method may comprise a representation of the S-boundary surface by a set of control points that modify the shape of the S-boundary. In one implementation of the calibration method, the control points may comprise linear B-Spline control points. In one implementation of the calibration method, the control points may be randomly perturbed according to a predetermined level of perturbation tolerance loaded from a data store. For example, the perturbation tolerance level may be set to le-4, or indeed the software may prompt the user to manually set a problem parameter and calibration method.

Thus it can be seen from the foregoing that the method disclosed herein provides an efficient numerical platform to form the cornerstone of the electromagnetic imaging problem, ie, the forward operator, and in particular the previously unavailable multi-level forward operator. In effect, the assembly process of the multi-level forward operator inherently/automatically provides means of compressing involved functions and operators, thereby providing unprecedented computational and storage savings, both of great interest in time-constrained, ie, real-time, applications. Moreover, as the concept of compression is immediately linked with the notion of numerical adaptivity the platform automatically lends itself to such applications at no additional computation cost. Furthermore, by employing the multilevel 1^{st} and 2^{nd} sets of solutions, the method disclosed herein is capable of generating a multilevel, ie, sparse, material distribution at no additional computational cost. Lastly, this computationally inexpensive process (by means of utilising multilevel 1^{st} and 2^{nd} solutions), of assembling the multilevel forward operator enables the efficient implementation of non-linear optimisation schemes, in particular, if combined with sparsity promoting methods, for example methods similar to those described in M. Gehre, T. Kluth, A. Lipponen, B. Jin, A. Seppanen, J. Kaipio, P. Maass. Sparsity reconstruction in electrical impedance tomography: an experimental evaluation. J. Comp. App. Math, 236(8), 2126-2136, 2012.

It will be appreciated that whilst various aspects and embodiments of the present invention have heretofore been described, the scope of the present invention is not limited to the particular arrangements set out herein and instead extends to encompass all arrangements, and modifications and alterations thereto, which fall within the spirit and/or scope of the invention.

For example, whilst illustrative embodiments described above employ software to implement the data processing method, it will be appreciated by persons skilled in the art that the functionality provided by that software may instead provided by hardware (for example by one or more application specific integrated circuits (ASICs)), or indeed by a mix of hardware and software.

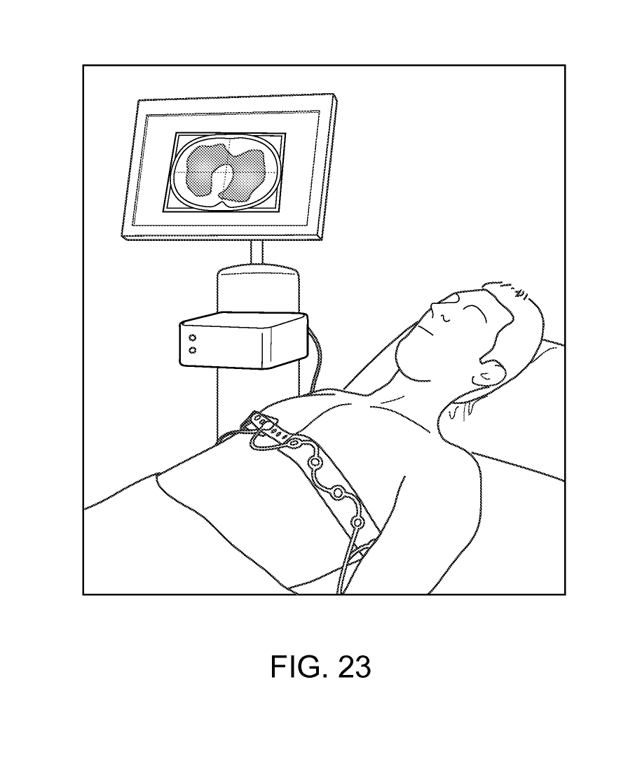

FIG. 23 illustrates a patient with a device for applying a current across the patient's skin in to order to measure a potential at various skin points to provide surface/boundary voltage data. The surface/boundary voltage data is transmitted to the computer and a processor of the computer is configured to generate the EIT image in accordance with a method of the present invention as disclosed above.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes modification and substitutions of equivalents may be made therein without departing from the spirit and scope of this invention which is intended to be unlimited by the foregoing except as may appear in the following appended claim. Therefore, the embodiments of the invention in which an exclusive property or privilege is claimed are defined in the following appended claims.

We claim as our invention:

1. A method of generating an image of a material distribution within an object, the method comprising the steps of:
a) obtaining or generating first and second sets of continuous equations in accordance with a set of imaging laws;
b) obtaining or generating first and second sets of basis functions that correspond to the first and second sets of continuous equations respectively;
c) generating a first set of discretised equations using the first set of basis functions and the first set of continuous equations;
d) generating a second set of discretised equations using the second set of basis functions and the second set of continuous equations;
e) solving the first set of discretised equations to generate a first set of solutions;
f) solving the second set of discretised equations to generate a second set of solutions;
g) extracting information regarding a first set of properties of the object from the first set of solutions;
h) extracting information regarding a second set of properties of the object from the second set of solutions;
i) utilising the information regarding the first and second sets of properties of the object to assemble a forward operator; and
j) utilising object data and the forward operator to generate image data, said image data corresponding to an estimation of the material distribution of the object.

2. The method of claim 1, wherein the first and second sets of basis functions obtained or generated in step b) are refinable.

3. The method of claim 2, wherein:
i) the first set of basis functions; and/or
ii) the second set of basis functions;
are of a single-scale nature or a multi-scale nature.

4. The method of claim 3, wherein:
i) the first set of discretised equations generated in step c) are either a first set of single-scale discretised equations or a first set of multi-scale discretised equations; and/or
ii) the second set of discretised equations generated in step d) are either a second set of single-scale discretised equations or a second set of multi-scale discretised equations.

5. The method of claim 4, wherein an iterative solver is used to solve:
i) the first set of single-scale discretised equations;
ii) the first set of multi-scale discretised equations;
iii) the second set of single-scale discretised equations; and/or
iv) the second set of multi-scale discretised equations.

6. The method of claim 5, wherein an iterative solver preconditioned with multigrid or an iterative solver of multigrid-type is used to solve:
i) the first set of single-scale discretised equations, thereby generating a first set of single-scale solutions; and/or
ii) the second set of single-scale discretised equations, thereby generating a second set of single-scale solutions.

7. The method of claim 5, wherein an iterative solver preconditioned with multilevel preconditioning is used to solve:
i) the first set of multi-scale discretised equations, thereby generating a first set of multi-scale solutions; and/or
ii) the second set of multi-scale discretised equations, thereby generating a second set of multi-scale solutions.

8. The method of claim 6, wherein:
i) step g) involves extracting a first set of single-scale properties of the object from the first set of single-scale solutions; and/or
ii) step h) involves extracting a second set of single-scale properties of the object from the second set of single-scale solutions.

9. The method of claim 7, wherein
i) step g) involves extracting a first set of multi-scale properties of the object from the first set of multi-scale solutions; and/or
ii) step h) involves extracting a second set of multi-scale properties of the object from the second set of multi-scale solutions.

10. The method of claim 8, wherein step i) involves utilising the first and second sets of extracted single-scale properties to generate a single-scale forward operator.

11. The method of claim 9, wherein step i) involves utilising the first and second sets of extracted multi-scale properties and/or the first set of single-scale properties and/or the second set of single-scale properties to generate a multi-scale forward operator.

12. The method of claim 10, wherein step j) involves using object data and the single-scale forward operator to generate single-scale image data.

13. The method of claim 11, wherein step j) involves using object data and the multi-scale forward operator to generate multi-scale image data.

14. The method of claim 12, wherein the single-scale forward operator is inverted to generate single-scale image data.

15. The method of claim 14, wherein the single-scale forward operator is inverted by using:
i) a linear solution process;
ii) a non-linear solution process; and/or
iii) a regularisation process.

16. The method of claim 13, wherein the multi-scale forward operator is inverted to generate multi-scale image data.

17. The method of claim 16, wherein the multi-scale forward operator is inverted by using:
i) a linear solution process;
ii) a non-linear solution process; and/or
iii) a regularisation process.

18. The method of claim 12, further comprising the step of using single-scale image data to calibrate the single-scale forward operator.

19. The method of claim 13, further comprising the step of using multi-scale image data to calibrate the multi-scale forward operator.

20. A method for generating an image of a material distribution within an object, the method comprising:
a) a processor of a computing device configured with a first software module for obtaining or generating first and second sets of continuous equations in accordance with a set of imaging laws;
b) the processor of the computer configured with a second software module for obtaining or generating first and second sets of basis functions that correspond to the first and second sets of continuous equations respectively;
c) the processor of the computer configured with a third software module for generating a first set of discretised equations using the first set of basis functions and the first set of continuous equations;
d) the processor of the computer configured with a fourth software module for generating a second set of discretised equations using the second set of basis functions and the second set of continuous equations;
e) the processor of the computer configured with a fifth software module for solving the first set of discretised equations to generate a first set of solutions;
f) the processor of the computer configured with a sixth software module for solving the second set of discretised equations to generate a second set of solutions;
g) the processor of the computer configured with a seventh software module for extracting information regarding a first set of properties of the object from the first set of solutions;
h) the processor of the computer configured with an eighth software module for extracting information regarding a second set of properties of the object from the second set of solutions;
i) the processor of the computer configured with a ninth software module for utilising the information regarding the first and second sets of properties of the object to assemble a forward operator; and
j) the processor of the computer configured with a tenth software module for utilising object data and the forward operator to generate image data, said image data corresponding to an estimation of the material distribution of the object, the object data comprising surface/boundary voltage data obtained from a device for measuring surface/boundary voltage across the object.
